(19) United States
(12) Patent Application Publication
(10) Pub. No.: US 2016/0341640 A1
(43) Pub. Date: Nov. 24, 2016

(54) SAMPLE PREPARATION DEVICES AND METHODS

(71) Applicant: LIFE TECHNOLOGIES CORPORATION, Carlsbad, CA (US)

(72) Inventors: Maxim BREVNOV, Union City, CA (US); James NURSE, Westport, WA (US); James STRAY, San Mateo, CA (US)

(21) Appl. No.: 15/157,011

(22) Filed: May 17, 2016

Related U.S. Application Data
(63) Continuation of application No. 12/896,584, filed on Oct. 1, 2010, now abandoned.
(60) Provisional application No. 61/248,300, filed on Oct. 2, 2009.

(51) Int. Cl. G01N 1/40

(52) U.S. Cl. CPC G01N 1/4005; G01N 2001/4016

(57) ABSTRACT

A device for sample processing can include at least one chamber having an egress, said chamber being configured to receive a sample for processing, a filter through which at least some sample portions in the at least one chamber flow, and a barrier member disposed in a first state to contain sample in the at least one chamber. Upon sufficient conditions, the barrier member can be alterable to a second state to permit flow of at least some sample portions contained in the chamber in a flow direction toward the egress and through the filter.

This application is a continuation of U.S. patent application Ser. No. 12/896,584 filed Oct. 1, 2010, which claims priority to U.S. Provisional Patent Application No. 61/248,300 filed Oct. 2, 2009, both of which are incorporated by reference herein in their entirety.

### TECHNICAL FIELD

The present teachings relate to devices and methods for sample preparation useful for various biological, chemical, and/or cytobiological applications.

### INTRODUCTION

The section headings used herein are for organizational purposes only and are not to be construed as limiting the subject matter described in any way.

Various biological, chemical, and/or cytobiological assay applications require sample preparation, such as, for example, the extraction and collection of target molecules from cells and other entities containing target molecules and/or other sample processing reactions. By way of nonlimiting example, target molecules may include, but are not limited to, for example, nucleic acids, proteins, peptides, polysaccharides and/or other biopolymers. For example, in food safety (e.g., pathogen detection), environmental, pharmaceutical, and forensic applications, to name a few, a sample may be analyzed to detect the presence and/or type, and/or otherwise to analyze, target molecules in the sample. In such applications, the target molecules first must be extracted from any entities containing the target molecules and isolated from the remainder of the contents of the sample, including, for example, solid sample material such as food, plants, soil, tissue, bone, keratinous fibers, and/or clothing, and cell debris and/or other impurities, proteins, etc. Under some conventional techniques, extraction and collection of target molecules, and/or other sample processing reactions, involve manual operation steps that may be expensive and/or time-consuming.

Exemplary steps in preparing a sample for assay and analysis of target molecules can include disruption, such as, for example, via lysis, of cells and/or other entities containing the target molecules to extract the target molecules therefrom; dissolving any extracted target molecules, for example, in a lysis medium; and separation and removal of the target molecules (including extracted target molecules and those present in extra cellular material) from other portions, such as insoluble portions, of the sample.

Conventional techniques for such sample preparation can be relatively time-consuming and involve relatively labor-intensive, manual intervention to move (such as via pipetting) the sample and other substances (e.g. reagents and/or lysis medium), if any, between various containers, such as, for example, containers for conducting a lysis reaction, containers for centrifuging, and containers for collecting the target molecules. Conventional techniques that use numerous sample transfer and/or manual intervention steps also can increase the risk of cross-contamination, loss of sample and/or target molecules, handling errors, and/or undesirable operator-to-operator variability. Moreover, some conventional techniques do not lend themselves well to portable sample preparation that can be readily used, for example, in the field when collecting sample to be prepared and/or processed for analysis and/or use.

It may be desirable, therefore, to provide a sample preparation technique that permits relatively rapid extraction and collection of target molecules from a sample. It also may be desirable to provide a technique for extracting and collecting target molecules from a sample that yields an amount of collected target molecules suitable for performing detection or other further analysis of the same. For example, in the case of collection of nucleic acids from a sample, it may be desirable to collect an amount of nucleic acids sufficient for detecting the nucleic acids via, for example, polymerase chain reaction (PCR). It also may be desirable to provide a sample preparation technique that reduces the number of parts and sample transfer steps. Additionally, it may be desirable to provide a portable sample preparation technique, for example one that permits the sample preparation and/or further analysis of the prepared sample to be performed in the field where the sample is collected.

More generally, it may be desirable to provide a sample preparation technique, including target molecule extraction and collection that achieves greater efficiency and uniformity in processing, and reduces the risk of cross-contamination, handling errors, and loss of sample.

### SUMMARY

Exemplary embodiments of the present teachings may solve one or more of the above-mentioned problems. Other features and/or advantages may become apparent from the description which follows.

In an exemplary embodiment, a device for sample processing can include at least one chamber having an egress, said chamber being configured to receive a sample for processing, a filter through which at least some sample portions in the at least one chamber flow, and a barrier member disposed in a first state to contain sample in the at least one chamber. Upon sufficient conditions, the barrier member can be alterable to a second state to permit flow of at least some sample portions contained in the chamber in a flow direction toward the egress and through the filter.

In another exemplary embodiment, the present teachings contemplate a device for sample processing that includes at least one chamber having an egress, said at least one chamber being configured to receive a sample for processing, a barrier member in a first state disposed relative to the at least one chamber, wherein in the first state the barrier member prevents flow of sample disposed in the chamber past the barrier member in a flow direction toward the egress, and wherein, upon sufficient conditions within the at least one chamber, the barrier member is alterable to a second state to permit flow of at least some sample portions disposed in the chamber past a location of the barrier member in the first state in a flow direction toward the egress. The device also can include a filter through which at least some sample portions in the at least one chamber flow when the barrier member is in the second state.

In another exemplary embodiment, the present teachings contemplate a method for preparing a sample that can include disposing a sample in a first chamber of a plurality of chambers fluidically connected in series, wherein consecutive chambers are separated from each other by respective barrier members in a first state, and subjecting the sample to a processing assay in the first chamber. The method can further include, after a predetermined time period, flowing at least some sample portions from the first chamber to a second consecutive chamber by altering the respective barrier member separating the first chamber and the second consecutive chamber to a second state, wherein the barrier member in the first state prevents flow past a location of the barrier member and wherein the barrier member in the second state permits flow from the first chamber to the second consecutive chamber.

In yet another exemplary embodiment, the present teachings contemplate a device for sample processing that can include at least one chamber having an egress, said at least one chamber being configured to receive a sample for processing, and a barrier membrane in a first state disposed relative to the chamber, wherein in the first state the barrier membrane contains the sample in the chamber. Upon sufficient conditions within the at least one chamber, the barrier membrane is alterable to a second state to permit flow of sample portions in the chamber in a flow direction toward the egress.

Additional objects and advantages may be set forth in part in the description which follows, and in part will be obvious from the description, or may be learned by practice of the present teachings. Those objects and advantages will be realized and attained by means of the elements and combinations particularly pointed out in the appended claims.

It is to be understood that both the foregoing general description and the following detailed description are exemplary and explanatory only and are not restrictive of the present teachings or claims.

### BRIEF DESCRIPTION OF THE DRAWINGS

The accompanying drawings, which are incorporated in and constitute a part of this specification, illustrate various exemplary embodiments of the present teachings and together with the description, serve to explain certain principles. In the drawings:

FIGS. 1A-1D are a schematic representation of an exemplary sample preparation workflow;

FIG. 2 is a side view of an exemplary embodiment of a sample preparation device in accordance with the teachings herein;

FIG. 3 is a cross-sectional view of an exemplary embodiment of a filter with a barrier member in accordance with the teachings herein;

FIGS. 4A-4D are a schematic representation of an exemplary sample preparation workflow in accordance with the teachings herein;

FIG. 5 is a plan view of an exemplary embodiment of a barrier member in accordance with the teachings herein;

FIG. 6 is a side, perspective view of another exemplary embodiment of a sample preparation device in accordance with the teachings herein;

FIG. 7 is a side view of yet another exemplary embodiment of a sample preparation device in accordance with the teachings herein;

FIG. 8 is a side view of an exemplary embodiment of a sample preparation device in conjunction with a syringe in accordance with the teachings herein;

FIG. 9 is a plan view of an exemplary embodiment of a filter and/or barrier member with a sealing mechanism in accordance with the teachings herein;

FIGS. 10A and 10B are side views of another exemplary embodiment of a sample preparation device in accordance with the teachings herein;

FIGS. 11A and 11B are side views of another exemplary embodiment of a sample preparation device in accordance with the teachings herein;

FIG. 12 is a side view of yet another exemplary embodiment of a sample preparation device in accordance with the teachings herein;

FIGS. 13 and 14A-D show schematic side views of yet another exemplary embodiment of a sample preparation device and workflow for using the device in accordance with the teachings herein;

FIGS. 15A-15C show a planar and side views of an exemplary embodiment of a sample preparation device and workflow in accordance with the teachings herein; and

FIG. 16 shows a side view of an exemplary embodiment of a sample preparation device having an integrated sample collection structure.

DESCRIPTION OF VARIOUS EXEMPLARY EMBODIMENTS

Reference will now be made in detail to various exemplary embodiments, some of which are illustrated in the accompanying drawings. Wherever possible, the same reference numbers will be used throughout the drawings to refer to the same or like parts.

To facilitate an understanding of the present teachings, the following definitions are provided. It is to be understood that, in general, terms not otherwise defined are to be given their ordinary meanings or meanings as generally accepted in the art.

As used herein, “sample” may refer to any substance or material that comprises target molecules and/or entities containing target molecules. A sample may include eukaryotic or/and prokaryotic cells, including, for example, pathogen cells, matter contained in cells, other pathogens, including viral particles, and/or matter contained in viral particles. Samples also may comprise extracellular matter, such as saliva, blood, urine, semen, food, keratinous material, calcified tissue, soil, plants (e.g., plant material), etc. that contains target molecules. Sample may also be used to refer to material on which any of the above are deposited, such as, for example, fabric, paper, textiles, etc. As used herein, a sample may also refer to any of the aforementioned materials mixed with other substances, such as, for example, buffers, reagents, and other substances that may react with the material or may be added to support a future reaction with the material.

The term “target molecules” as used herein refers to the molecules of interest in a sample that one wishes to isolate from other portions of the sample to collect in order to perform any of a variety of assay and/or analysis. Target molecules may include, but are not limited to, for example, nucleic acids, proteins, peptides, polysaccharides, and/or other small biopolymer molecules.

The term “nucleic acid” can be used interchangeably with “polynucleotide” or “oligonucleotide” and can include single-stranded or double-stranded polymers of nucleotide monomers, including 2′-deoxyribonucleotides (DNA) and ribonucleotides (RNA) linked by internucleotide phosphodiester bond linkages, or internucleotide analogs, and associated counter ions, for example, H+, NH4+, trialkylammonium, Mg2+, Na+ and the like. A polynucleotide may be composed entirely of deoxyribonucleotides, entirely of ribonucleotides, or chimeric mixtures thereof. Polynucleotides may be comprised of nucleobase and sugar analogs. Polynucleotides typically range in size from a few monomeric units, for example, 5-40 when they are frequently referred to in the art as oligonucleotides, to several thousands of monomeric nucleotide units. Unless denoted otherwise, whenever a polynucleotide sequence is represented, it will be understood that the nucleosides are in 5′ to 3′ order from left to right and that “A” denotes deoxyadenosine, “C” denotes deoxycytidine, “G” denotes deoxyguanosine, and “T” denotes thymidine, unless otherwise noted. A labeled polynucleotide can comprise modification at the 5′terminus, 3′terminus, a nucleobase, an internucleotide linkage, a sugar, amino, sulfide, hydroxyl, or carboxyl. See, for example, U.S. Pat. No. 6,316,610 B2, which issued Nov. 13, 2001 and is entitled “LABELLED OLIGONUCLEOTIDES SYNTHESIZED ON SOLID SUPPORTS,” which is incorporated herein by reference. Similarly, other modifications can be made at the indicated sites as deemed appropriate.

“Filter,” “filtration” and variations thereof as used herein may refer to any material or technique by which it is possible to separate materials on the basis of a predetermined characteristic. By way of example, filters may comprise a structure configured to pass material smaller than a certain (threshold) size from one side of the filter to the other while blocking the passage of other material equal to or larger than the threshold size. Filters or filter materials herein may therefore pass liquids, gases, and solids, but may be configured so as to exclude various materials from passage on the basis of size. “Functionalized resins”, “resins,” and variants thereof also can be considered as filters. As used herein, “functionalized resins” can refer to various materials or media that are capable of interacting with a sample or portions of a sample to react with the sample and/or process the sample as the sample is contacted with the functionalized resin or functionalized media. Functionalized resins can include a variety of materials and/or media and should not be construed herein as limited to a particular material or media. Exemplary materials and/or media that can be used for functionalized resins include gels, discrete solid supports (e.g., beads), and a variety of polymers. Functionalized resins can be treated chemically and/or enzymatically to react with portions of the sample that come into contact with the resins, for example, to capture the sample to the resin via affinity binding and/or exchange, or to otherwise react with the sample. Functionalized resins also can include materials that effect separation of portions of the sample on the basis of molecular size as those portions pass through the resin.

The term “pathogens” as used herein may refer to any of a variety of pathogen cells or viral particles, wherein pathogen cells may include, but are not limited to, for example, molds, bacteria, protozoa, fungi, parasites, pathogenic proteins (e.g., prions).

As used herein, an “entity containing target molecules” and variants thereof may refer to eukaryotic or prokaryotic cells and/or microorganisms, including pathogens (as defined above), other types of cells, biological tissues, and/or any other unit or portion of a sample containing target molecules.

The term “disruption,” “disrupting,” “disrupt,” and variants thereof, when used herein in the context of disrupting entities containing target molecules may include any process for effecting the extraction of target molecules from an entity containing target molecules. Such processes may include, for example, rupturing or otherwise breaching the outer boundary of a cell (e.g., the cell's membrane and/or wall), including a pathogen cell, and/or the outer boundary of a viral particle (e.g., the viral envelope and/or capsid) to release target molecules contained therein. Other processes include extracting the target molecules that may be deposited on or within a sample material, such as, for example, blood on fabric, textile, or paper. Also, it should be noted that reference to disrupted sample herein refers to a sample containing entities that have been subjected to disruption and/or a sample in which target molecules have been extracted directly from the sample material; similarly, reference to disrupted entities can refer to cells, pathogens, and/or other entities that have been subjected to disruption.

Although many of the exemplary embodiments described utilize chemical or enzymatic lysing to achieve disruption, it should be understood that any of a variety of disruption techniques known to those skilled in the art could be used in lieu of or in combination with the chemical or enzymatic lysing. Examples of suitable disruption techniques include, but are not limited to, thermal, electrical, and/or mechanical techniques. Mechanical techniques may include, for example, agitating the sample and entities therein by any of a variety of mechanisms, e.g., beads, vibration, sonication, and/or passing the sample through structures that can cause shearing of entities containing target molecules to rupture the outer boundaries of those entities. In various exemplary embodiments, disruption should not significantly break apart the target molecules. In various exemplary embodiments, it is contemplated that a lysing reagent can be predeposited in a container to which sample is introduced or may be added to the sample from which it is desired to release nucleic acids, as desired.

As used herein, when reference is made to a “reagent,” it should be understood that a reagent is not necessarily limited to a single active component. Rather, a “reagent” can refer to a composition comprising multiple active components or a single active component. Also, in some instances throughout the specification, “reagent” may be used to refer to substances including buffer solutions and/or other substances added to a sample to prepare the sample, or otherwise react with or support a reaction with the sample

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” and any singular use of any word, include plural referents unless expressly and unequivocally limited to one referent. Thus, for example, reference to “a sample” can include two or more different samples. As used herein, the term “include” and its grammatical variants are intended to be non-limiting, such that recitation of items in a list is not to the exclusion of other like items that can be substituted or added to the listed items.

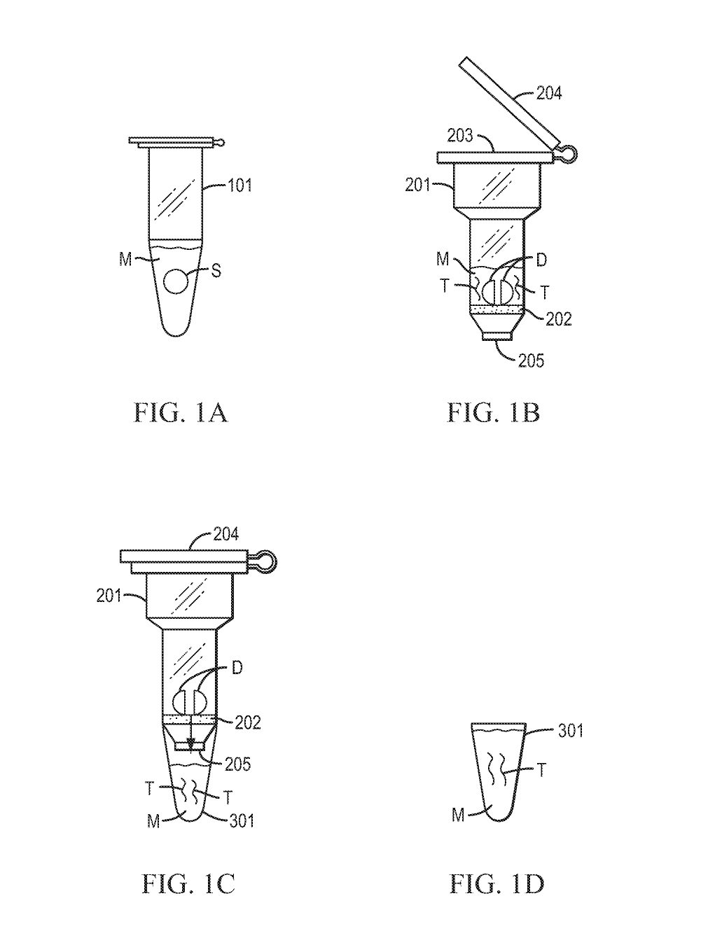

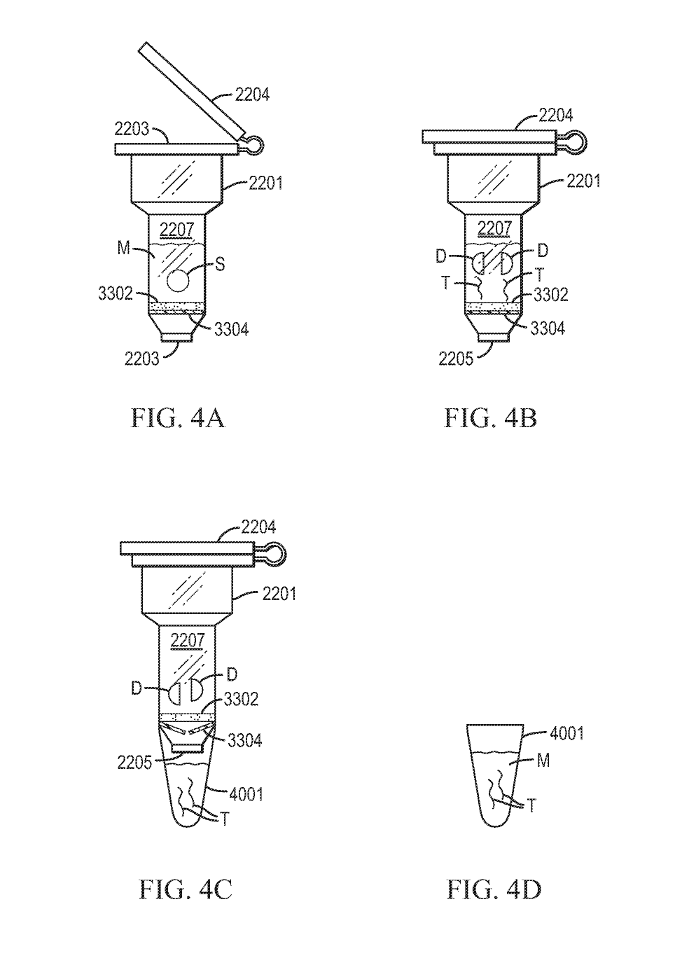

An exemplary workflow for preparing samples for target molecule assay and analysis, including but not limited to, for example, food safety (including animal, dairy, fruit and/or vegetable care), environmental, forensic and/or pharmaceutical applications, is depicted schematically in FIG. 1. To simplify the detailed description and drawings, some of the drawings (i.e., FIGS. 1 and 4) depict a sample S represented as a single unit that breaks apart to release target molecules therefrom (e.g., analogous to a single cell releasing the target molecules). It should be understood, however, that the sample can contain a plurality of cells and/or other entities that can be disrupted to release the target molecules. In addition to or in lieu of the sample comprising entities containing target molecules, the sample itself may contain the target molecules directly, such as, for example, blood or other human or animal secretion collected on fabric, textile or a paper, and the sample can be processed to extract the target molecules from the sample. Thus, various depictions herein are schematic only and intended to represent the sample comprising target molecules (whether in entities or other form) being processed to extract target molecules therefrom. In FIG. 1A, a sample S of interest comprising target molecules, along with a lysis medium and/or other reagents, labeled collectively as M, may be introduced in a chamber defined by tube 101, which in the embodiment shown is closed at one end and closable by a cap at the other. The lysis medium may include a chemical and/or enzymatic lysis agent. The sample S and lysis medium and/or other reagents M may be held in the tube 101 for an amount of time sufficient to permit the disruption of any entities containing target molecules and/or otherwise to effect the extraction of target molecules from the sample S. During this time period, the tube 101 may be heated and/or agitated, such as via vibration, rotation, stirring, and/or mixing via any of a variety of mechanisms known to those skilled in the art, to facilitate the mixing of the lysis medium and sample and/or the disruption of the sample (e.g., including entities within the sample).

After sufficient time has passed to allow for disruption and extraction of target molecules T into the medium M, the contents of the tube 101, which include the extracted target molecules T, debris from the disrupted entities (e.g., cell membrane and/or capsid debris) and/or other portions of the sample insoluble in the lysis medium (generally designated by reference label D), lysis and/or reagent media M, and any other substance present in the tube, are transferred to a tube 201 (which in one exemplary embodiment may be a spin tube, also referred to as a spin column) in FIG. 1B. In one embodiment, the tube 201 may have the configuration of the spin tube sold by Applied Biosystems of Life Technologies Corp. under the tradename LySep™. In an exemplary embodiment, the contents of the tube 101 are transferred via pipetting, which is typically done manually, for example by a laboratory professional, but could also be done by an automated fluid handling system.

The phrase tube is used herein to refer to structures that are generally hollow and can pass and/or contain material. Tubes herein can include structures that are open at both ends or structures that have at least one closed or closable end. Although various exemplary embodiments in the drawings depict tubes having generally cylindrical configurations, such configurations are nonlimiting and exemplary only, and tubes in accordance with the teachings herein can have a variety of cross-sectional shapes, such as, for example, oval, square, rectangular, or other polygonal shape etc.

The tube 201 has two openings at opposing ends configured to permit the ingress and egress of contents to and from the tube 201. A filter 202 is disposed proximate an egress 205 so as to define a volume above the filter 202 configured to receive the disrupted sample from the tube 101. The filter 202 may be a finely porous material that permits passage of material smaller than a threshold size, such as, for example, the target molecules T and lysis medium and/or other liquid substance M, such as, reagents, that may be placed in the tube 201. The porous material excludes from passage material of at least the threshold size (indicated generally by D). Examples of such material that are excluded from passage through the filter may include, but are not limited to, foodstuffs, tissue, keratinous fibers, clothing, soil, bone and/or any other solid matter present in the original sample, as well as cell membranes, cell walls, and/or other debris remaining after the disruption process.

In an exemplary embodiment, the filter 202 may be substantially disk-shaped so as to fit within the tube 201, for example, via a press-fit engagement with the interior wall surfaces of the tube 201. The size and shape of the filter 202 may be selected so as to eliminate any gaps between the lateral surfaces of the filter 202 and the interior wall surfaces of the tube 201. In one exemplary embodiment, a sealing mechanism (labeled as 2002 in the plan view of the filter 202 and sealing mechanism in FIG. 9), such as, for example, a film of wax, polymer, or plastic, an o-ring, or a metallic foil, may be placed around the perimeter of the filter 202 between the filter 202 and the interior wall of tube 201 to assist in preventing leakage of the contents of the tube 201 laterally around the sides of the filter 202. As shown in FIG. 9, the sealing mechanism 2002 can have a substantially annular shape and can be bonded to the filter 202, for example, by adhesive, laser welding, ultrasonic welding, or other bonding techniques, with the filter 202 and the sealing mechanism 2002 together being fit into the tube 201. In an exemplary embodiment, the filter 202 may be a frit, made, for example, of fused granular polymeric material, such as, Porex®. Other suitable fused granular polymeric materials may include, for example, polyethylene, polypropylene, polyethylene terephthalate (PET) and polytetrafluoroethylene (PTFE), such as Teflon, or combinations thereof. In various exemplary embodiments, a nominal pore size of the filter may range from about 0.2 microns to about 500 microns; however, the pore size may be selected so as to achieve a desired size-exclusion of materials. In an exemplary embodiment, the filter may comprise a frit material with holes of a desired size in the frit so as to permit passage of material less than a threshold size and prevent passage of a material greater or equal to the threshold size. In other exemplary embodiments, the frits can be a track-etched membrane, or a sintered material (e.g., a thermal compression bonding of materials to form a matrix).

Once the disrupted sample has been transferred, as shown in FIG. 1B, to the tube 201, a lid 204 (which can include a vent hole (not shown)) may be positioned to close the tube 201 and the tube 201 may be placed in cooperation with a collection tube 301, as shown in FIG. 1C. As depicted in FIG. 1C, the contents of the tube 201 may be subjected to a force to assist (e.g., along with gravity) in moving at least some of the contents above the filter 202 to move (flow) in a direction generally toward the egress 205 and collection tube 301. For example, in an exemplary embodiment, the tube 201 and collection tube 301 can be centrifuged together, for example, using a microcentrifuge or other centrifuging instrumentation with which those having ordinary skill in the art are familiar. During centrifuging, the target molecules T extracted from the sample S, soluble matter from the sample S, and any lysis, reagent, and/or other liquid-based media M in the tube 201 pass through the filter 202 into the collection tube 301. Material D of larger size, such as, for example, relatively large sample material that is insoluble in the lysis medium, cell debris, and the like can be separated from the smaller and/or liquid contents of the tube 201 due to the inertial forces acting on the larger (e.g., heavier) material and can be excluded from passage through the small pores (and/or formed holes) of the filter 202, thereby remaining in the tube 201. After centrifuging is complete, therefore, extracted target molecules T, along with lysis medium and/or other reagents M if present, will be separated from other portions of the sample material and contained in the collection tube 301, as depicted in FIG. 1D. An amount of target molecules T can be collected that is sufficient to perform further processing and/or desired assay and analysis, such as, for example, PCR. In an exemplary embodiment, the collection tube 301 also may include a lid or other cover (not shown) to permit transportation of the collection tube 301 and its contents received from the tube 201 for further processing, and to reduce the risk of losing and/or contaminating the contents in the collection tube 301.

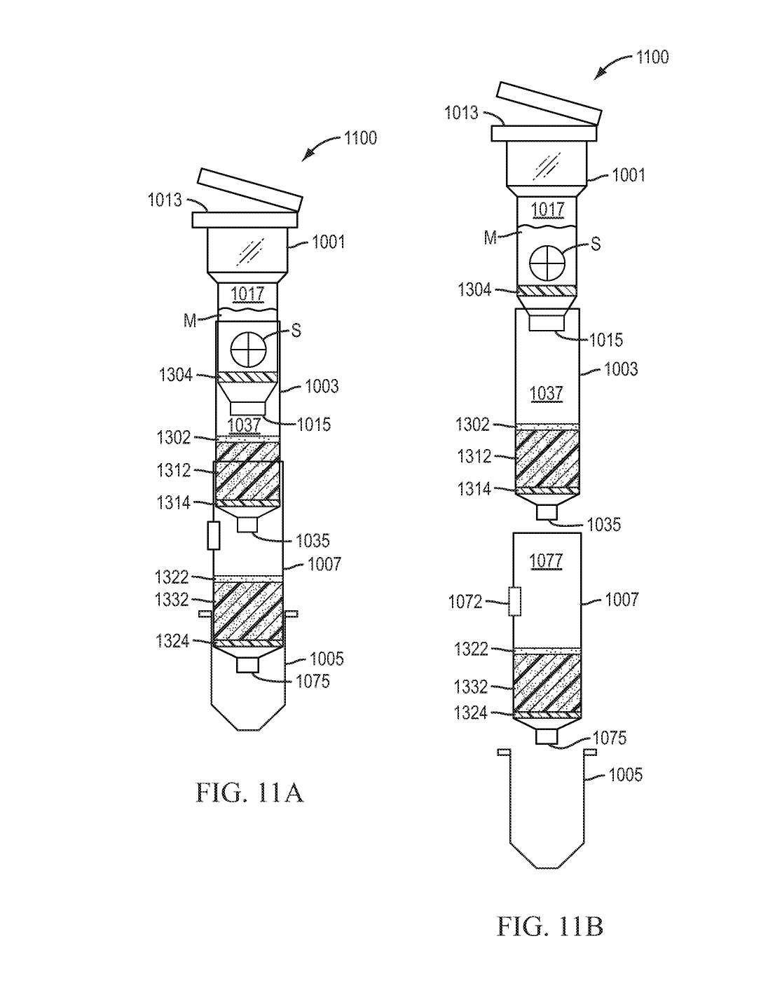

Although the above example is described as utilizing centrifugation, other mechanisms may be used in lieu of or in conjunction with centrifugation to assist in drawing the target molecules T and liquid-based medium M through the filter 202. By way of example, other mechanisms can include, but are not limited to, the application of pressure, e.g., created via a positive pressure mechanism or vacuum, to force the contents through the filter 202. Regarding the application of positive pressure, in an exemplary embodiment, a syringe could be introduced, for example through a septum (not shown) covering the tube 201 (e.g., in cover 204) or otherwise disposed in the tube 201 (e.g., in a side wall of the tube, for example, as shown in FIG. 11), to create a positive pressure above the filter 202. Alternatively, with reference to FIG. 8, in an exemplary embodiment, the collection tube 301 may be replaced with a syringe barrel 801 and a syringe may be introduced through the opening 205 of the tube 201 by way of a septum and/or a luer lock to create a vacuum force to draw the target molecules T and medium M from the tube 201.

A potential drawback of the exemplary workflow of FIG. 1 includes the number of times and manner in which the sample is transferred between different containers, making the workflow relatively labor-intensive and time-consuming. For example, the sample must be transferred first to the tube 101, then to the tube 201, and finally to the collection tube 301. As mentioned above, the transfer from the tube 101 to the tube 201 is typically achieved via pipetting, which can include manual pipetting. Aside from being relatively time-consuming, the risk of cross-contamination, handling errors, exposure to pathogens, exposure to hazardous waste, and loss of sample exists each time the sample is transferred.

Various exemplary embodiments of the present teachings set forth herein provide a sample preparation and/or processing workflow and system that is robust, efficient, and reduces the risk of cross-contamination, handling errors, pathogen or other hazardous material exposure, and/or sample loss by reducing the number of components used in the workflow and the number of times the sample of interest is manually transferred between different containers or devices. Moreover, exemplary embodiments of the present teachings may reduce laboratory waste, for example, by creating more efficient transfer processes and a simple, robust way to collect waste, which may include hazardous waste. In various exemplary embodiments, numerous processes (e.g., reactions, disruption, filtration, binding, labeling, ion-exchange, size separation, etc.) are carried out in the same device (e.g., including in an integrated fluidically connected system of device components) rather than in separate components not fluidically integrated. This can eliminate manual steps, including the need to transfer the sample between non-fluidically connected devices after the disruption process. Further, in various exemplary embodiments, sample and any substances mixed with the sample (e.g., lysis medium and/or other reagents) may be held in a sample preparation device for a time period sufficient to achieve a desired reaction, for example, disruption and extraction of target molecules, prior to a filtration or other separation process occurring; in this manner, various exemplary embodiments permit the filtration (separation) process to selectively and automatically occur at a desired time, despite the in situ location of the filter in the sample preparation device in which the disruption occurs. Moreover, various exemplary embodiments provide for the transfer of the liquid, soluble matter, and extracted target molecule or other contents of interest from a chamber in which sample processing (e.g., disruption, washing, desalting, binding, exchange, size separation, and/or other reaction) occurs, through a filter and into a downstream collection chamber (e.g., in a collection tube or other container) or additional processing chamber in a controlled and automatic manner, and at a selected time, without the need for manual intervention. Sample preparation devices and methods in accordance with the teachings herein also can provide high collection rates of target molecules, for example, greater than about 90% of the initial amount of target molecules in the sample can be collected.

It should be understood that use of the term sample preparation herein can include a variety of processes and reactions that ready a sample for a desired end-analysis or use, and the teachings herein are not intended to be limited to the application of lysis and collection of target molecules from a sample. Other applications for which various exemplary embodiments herein can be used include but are not limited to the radioactive labeling of pharmaceuticals, the enzymatic treatment of a sample with enzymes, such as, for example, DNase or Proteinase K enzymes, covalently attached to a resin/solid phase material, and/or the affinity labeling of antibodies and antibody binding to detect or deplete a sample of antibodies or to detect antigens in sample with antibodies attached to a resin/solid phase material. Various exemplary embodiments offer sample preparation devices that are relatively simple and inexpensive to use and make, and that can be disposable after use. Alternatively, devices and methods can be configured to be reused with appropriate cleaning techniques.

Moreover, various exemplary embodiments contemplate portable devices and techniques to permit, for example, a sample preparation and/or processing workflow to be carried out at the point of collection of the sample in the field, such as, for example, when collecting a human sample, soil, animal/plant sample, etc., and it is desirable to prepare and/or process the collected sample at the time of its collection in a sterile manner.

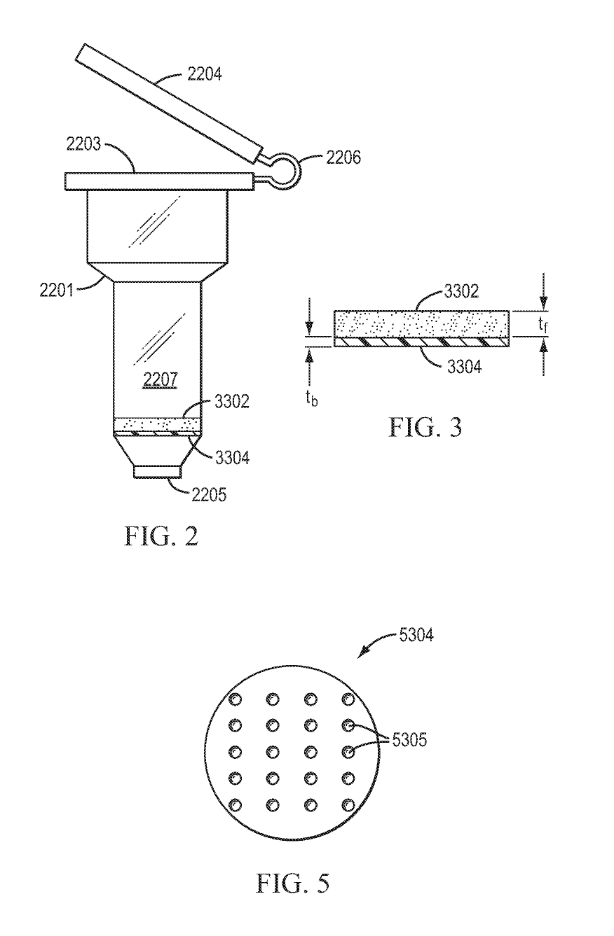

Referring now to FIG. 2, an exemplary embodiment of a sample preparation device in accordance with the teachings herein is illustrated. In FIG. 2, a sample preparation device comprises a tube 2201 defining a chamber 2207 and having openings at opposite ends respectively configured for introducing contents into and flowing contents out of the tube 2201. In the exemplary embodiment of FIG. 2, the tube 2201 defines a relatively large opening 2203 at one end thereof configured as an ingress for introducing contents into the tube 2201, and a relatively small opening 2205 at another opposite end configured as an egress through which contents can flow out of the tube 2201. In an exemplary embodiment, a lid 2204 may be provided to close the opening 2203 in a substantially leak-proof manner, similar to that shown in FIG. 1. If needed, a small vent hole (not shown) may be provided in the top of the lid 2204. The lid 2204 may be attached to the tube 2201 via a flexible tether 2206 or may be separate from the tube 2201 (not shown) and be configured to engage and close the opening 2203. The lid 2204 may engage with the tube 2201 in numerous ways as would be obvious to those skilled in the art to close the opening 2203 in a substantially leak-proof manner.

Disposed in the tube 2201 is a filter 3302 with a barrier member 3304 attached to a surface of the filter 3302. In the exemplary embodiment of FIG. 2, the filter 3302 and barrier member 3304 are positioned in the tube 2201 with the barrier member 3304 facing the relatively small opening 2205. In various exemplary embodiments, the filter 3302 and barrier member 3304 may have an overall disk shape and be configured to fit within the tube 2201 so as to be retained in the tube 2201, for example, via press-fit engagement, even upon an increase in pressure within the chamber 2207 of the tube 2201. The size and shape of the filter 3302 and barrier member 3304 may be selected so as to eliminate any gaps between the lateral surfaces of the filter 3302 and barrier member 3304 and the interior wall surfaces of the tube 2201, so as to prevent the contents placed in the tube 2201 from passing between the interior wall surfaces of the tube 2201 and the lateral surfaces of the filter 3302 and barrier member 3304. As described above, in an exemplary embodiment, a sealing mechanism, such as the sealing mechanism 2002 described above with reference to FIG. 9, may be provided around and bonded to the outer perimeter of the filter 3302 and/or barrier member 3304 between the filter 3302 and/or barrier member 3304 and the interior wall of the tube 2201 to substantially prevent leakage of substance around the edges of the filter 3302 and/or barrier member 3304 and/or to create a vacuum seal or fluid seal.

In various exemplary embodiments, the tube 2201 may be made of a plastic material, such as, for example, a polymer including but not limited to polyethylene and/or polypropylene. In one embodiment, the tube 2201 is formed via injection molding. The tube 2201 may be configured to hold a volume ranging from about 0.01 milliliters (mL) to about 10 mL, or for example to about 50 mL, for example, from about 0.05 mL to about 3.0 mL. However, those having ordinary skill in the art would understand that the specified volume range is exemplary only and the teachings herein could be utilized with a wide range of volumes depending, for example, on the format of the device holding the sample for processing and the particular sample processing application. Volumes of sample that can be prepared in accordance with devices and methods disclosed herein range from about 50 microliters (μL) to about 50 mL for smaller-scale applications, to 100 liters or more for larger-scale (e.g., industrial applications). In various exemplary embodiments relying on larger container structures, such as, for example, flexible bags and the like, the volumes of such sample chambers defined by the containers may range from 1 liter to 100 liters or more, which can be suitable for industrial applications for example. Moreover, other sample preparation device formats that can be utilized and are considered within the scope of the teachings herein include, but are not limited to, well-plates (e.g., 96-, 384-, and other or larger formats, such as formats with an array of 14 locations in a row), capillary tubes, flexible pouches, etc., exemplary embodiments of some of which will be shown and described in more detail below.

FIG. 3 shows a cross-sectional view of the filter member 3302 and barrier member 3304 in isolation. As described above with reference to FIG. 1, the filter 3302 may be made of a finely porous material that permits passage of the extracted target molecules and liquid contents (e.g., reagent and/or lysis media) of the spin tube 2201, but excludes from passage larger and/or other portions of the sample material insoluble with the liquid contents. Examples of such material that are excluded from passage through the filter may include, but are not limited to, foodstuffs, tissue, clothing, soil, keratinous fibers, bone and/or any other solid matter present in the original sample, as well as debris from disrupted cells and/or other entities. In an exemplary embodiment, the filter 3302 may be a frit, made, for example, of fused granular polymeric material, such as, Porex®. Other suitable fused granular polymeric materials may include, for example, polyethylene, polypropylene, polyethylene terephthalate (PET), polytetrafluoroethylene (PTFE), such as Teflon, or combinations of thereof. In various exemplary embodiments, a nominal pore size of the filter may range from about 5 microns to about 1.0 millimeter, for example from about 5 microns to about 0.5 millimeters.

In various exemplary embodiments, the thickness of the filters disclosed herein, including filter 3302, may range from about 1/254 in. to about ¼ in., for example, the thickness t_{f} may be about 1/16 in. In various exemplary embodiments, the thickness of the filter element may be selected so as to permit an amount of target molecules to pass therethrough such that a sufficient amount is collected for the purposes of performing a desired assay and/or analysis. In various exemplary embodiments, the pore size of the filters disclosed herein, including filter 3302, may range from about 5.0 microns to about 1.0 millimeter. However, the porosity may be selected as desired to achieve various size exclusion properties and/or disruption of selected entities as desired.

For reasons that will be explained in further detail below, in various exemplary embodiments, the filter 3302 may exhibit hydrophobic characteristics. For example, the filter 3302 may be made of a material that is hydrophobic. The fused granular polymeric materials, including those having the pore sizes indicated above, are hydrophobic. Alternatively or in addition to use of a hydrophobic material, the filter 3302 may be treated (e.g., coated) with a hydrophobic substance, such as, for example, Repel-Silane (e.g., silane, dichlorodimethyl).

Moreover, in various exemplary embodiments, the filter 3302 may be configured to cause disruption of entities (e.g., pathogens, tissues, cells, etc.) as they pass through the filter 3302. For example, the porosity (e.g., including size and shape of the pores) of the filter 3302 may be selected so as to achieve a disruption effect upon entities passing through the filter 3302 to further release target molecules as sample passes therethrough. In an exemplary embodiment, the filter 3302 may be configured to disrupt differing types of entities than the disruption process that occurs in the chamber 2207 of the tube 2201 above the filter 3302. For example, a different size or kind of entity may be disrupted in the tube 2201 above the filter 3302, for example, through chemical and/or enzymatic lysis, and other entities may be disrupted during passage through the filter 3302. In various exemplary embodiments, the filter 3302 may also be treated so as to become functionalized, for example, permitting selective binding (or not) of molecules or other entities to the filter during passage therethrough. Nonlimiting examples of such functionalization include hydroxy-, carboxy-, amino-, and silanol functionalization.

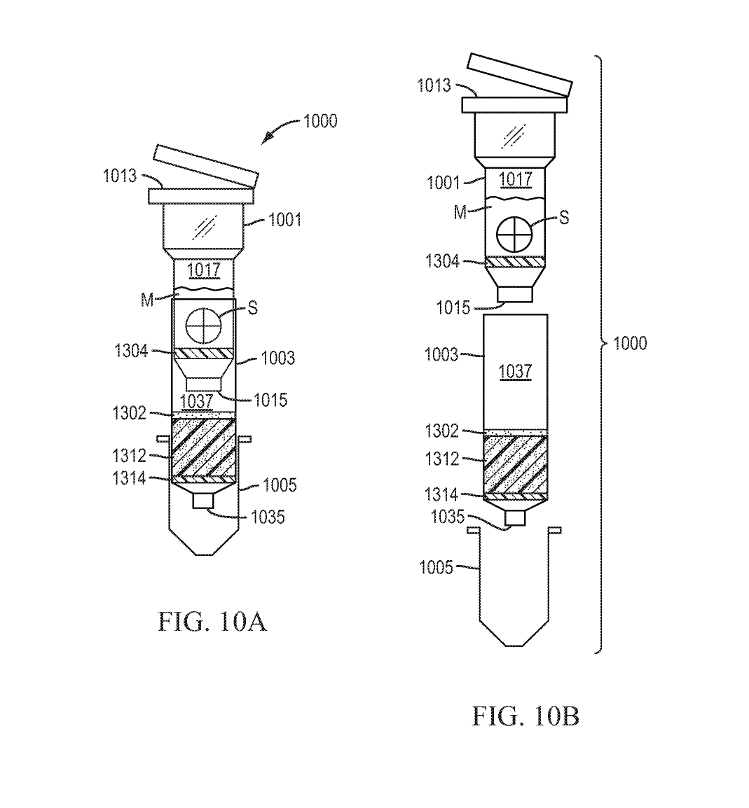

Although only a single layer filter 3302 is depicted in FIG. 3 and in various exemplary embodiments shown in the figures, the filter instead could comprise a plurality of layers, and the layers may have differing configurations and/or properties. For example, different layers could have different porosities (for example, to exclude differing sizes of material and/or to shear (disrupt) differing types and/or sizes of entitles), thicknesses, and/or be treated and/or functionalized in different manners, as desired. Those having ordinary skill in the art would understand how to choose different types of filter layers to achieve various functions depending on the specific application desired. For example, as will be described below with reference to additional exemplary embodiments such as FIGS. 10 and 11, the filter may include a layered structure (e.g., a multilaminate structure) that includes one or more size-exclusion filter structures (e.g., frit structures) and one or more functionalized resin structures, with the size-exclusion structure being configured to prevent the passage of relatively large material, such as, for example cell debris and/or larger insoluble sample material, and the resin being configured as a molecular sieve (that is, to permit separation of molecules based on the size of the molecule), an exchange, and/or other capture structure as will be described in more detail below. In various exemplary embodiments, the functionalized resin structures could be ion-exchange resins and/or affinity-binding resins that capture molecules or other entities of interest as they pass therethrough. The filters, whether frits or resin structures or other materials, also may be treated with various reactants and/or catalysts that may cause and/or support a desired reaction with the material that passes through the filter. In some exemplary embodiments, functionalized resins may not exclude material from passage or separate materials, but can just incorporate a catalyst, binding moiety, or other reactant into the material passing therethrough. In various exemplary embodiments, functionalized resin structures can incorporate antibodies into the resin.

A variety of materials may be used to form the functionalized resin structures and those of ordinary skill in the art would appreciate how to select materials based on a desired application. Suitable exemplary materials include, but are not limited to, materials comprising polyacrylamide, polydextran (e.g., which can be used for molecule exclusion), Sephacryl™, Sepharose™, Sephadex™, cationic and anionic exchange resin materials, such as, for example, Q (+) (quatenary amine), DEAE (+) (diethylamino ethyl), CM (−) (carboxymethyl) or SP (−) (sulfopropyl) moieties coupled to cellulose, Sephacryl™, Sephadex™, or Sepahrose™ type, resins.

In an exemplary embodiment, the barrier member 3304 may be a structure that is alterable from a first state, wherein the barrier member 3304 is substantially impermeable to prevent passage of sample and other contents in the tube 2201 past the barrier member 3304, to a second state of the barrier member, wherein the barrier member 3304 in the second state permits passage of at least portions of the processed contents of the tube 2201 past the initial location of the barrier member 3304 toward the egress 2205.

In an exemplary embodiment, the barrier member 3304 can include a thin film or membrane made of, for example, a polymer such as polyethylene, for example high density polyethylene, or other polymers, a metallic foil, or other deformable or yieldable material. The barrier member 3304 may have a thickness t_{b} ranging from about 0.1 mils (0.001 in.) to about 10 mils, for example, the thickness t_{b} may be about 0.5 mils. Upon being subjected to sufficient pressure, the barrier member 3304 can be configured to rupture or otherwise yield to create at least one passage through which liquid and other substances passing through filter 3302 can flow toward the egress 2205. By way of example, the barrier member 3304 can be configured to yield (e.g., rupture) during centrifuging of the spin tube 2201 under centrifugal accelerations ranging from about 100 G to 16000 G, for example, about 1000 G.

Additionally or alternatively, the barrier member 3304 can be configured to yield upon exertion of a pressure created in the tube 2201, for example, via thermal, pneumatic, hydraulic, and/or other mechanisms configured to increase the pressure in the chamber 2207 of the tube 2201 above the filter 3302. In various exemplary embodiments, barrier members can be configured to yield under pressures ranging from about 0.05 bars to about 100 bars, for example from about 1 bar to about 20 bars. By way of example, a syringe can be used to create a positive pressure above the filter 3302 in tube 2201 that is sufficient to yield the barrier member 3304 or to create a negative pressure (vacuum) in the tube 2201 below the filter 3302 that is sufficient to yield the barrier member 3304. In another embodiment, an electrical, magnetic, or thermal action upon the substances in the tube 2201 above the filter 3302 can be used to increase the pressure therein to a level sufficient to cause the barrier member 3304 to yield. In yet another exemplary embodiment, a pellet or other substance may be placed in the tube 2201 above the filter 3302 that, when contacted with a liquid medium, forms a gas that increases the pressure in the tube 2201 to a level sufficient to rupture the barrier member 3304; in such a case, the tube 2201 can be closed by cover 2204 in a substantially sealed manner.

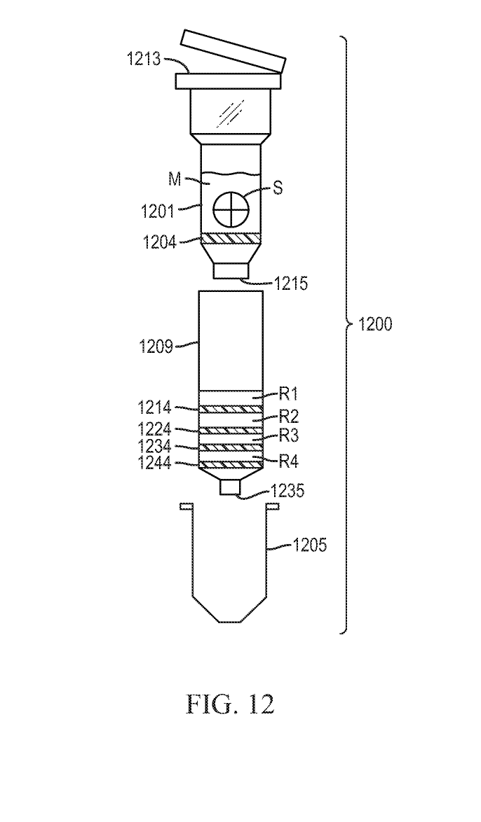

Although the exemplary embodiments described above utilize an increase in pressure or other force to alter the barrier member from the first state wherein the barrier member is impermeable to the second state wherein the barrier member permits flow of at least some materials toward the egress 2205, other barrier member configurations also are contemplated. By way of example, a barrier member in accordance with the teachings herein can be made of a material, such as for example, rubber, wax, soft plastics, hydrogels, or other phase-change materials, that melts and/or otherwise deteriorates upon exposure to a threshold temperature (i.e., exposure to a sufficient amount of heat). In another exemplary embodiment, a barrier member in accordance with the teachings herein can be made of a material that is soluble under certain conditions. For example, the material may be soluble so as to dissolve after being in contact for a predetermined time period with the contents placed in the tube 2201; the predetermined time period in one embodiment being a time period sufficient to permit the desired reaction (e.g., lysis) of the sample in the tube 2201 to occur. Another condition that can be modified to control the solubility of the barrier member includes, but is not limited to, for example, temperature. In yet another exemplary embodiment, a barrier member in accordance with the teachings herein can achieve passage of material via osmosis (e.g., the barrier member can comprise an osmotic membrane), for example, via alterations to the pH of the sample and/or barrier to allow the sample, or portions thereof, to pass through the barrier with the concurring change in pH. To achieve osmosis through the barrier member, in exemplary embodiments the barrier member can be kept hydrated. The exemplary embodiment of FIG. 12, described below, is an example of an embodiment that may be particularly suitable for using such an osmotic barrier member.

Those having ordinary skill in the art will appreciate that a variety of actions, including mechanical, electrical, chemical, and/or combinations thereof, can be employed to alter the state of the exemplary barrier members herein from a state in which they prevent the passage of sample and/or other contents in a tube with which they are associated (e.g., so as to permit a desired reaction and/or process to occur on a sample held in a chamber by virtue of the barrier member) to a state in which they permit the passage of the reacted and/or processed sample and/or other contents so as to collect the passed portions of the sample for additional processing and/or analysis.

Referring now to FIG. 4, an exemplary workflow for using the tube 2201 to separate and collect target molecules from a sample of interest is schematically depicted. In FIG. 4A, a sample S of interest comprising target molecules, along with a lysis medium and/or other reagents M, are introduced into the tube 2201 and held therein in the chamber 2207 of the tube 2201 above the filter 3302. The sample S and lysis medium and/or other reagents M may be held in the tube 2201 for an amount of time sufficient to permit the disruption of the sample S containing target molecules T to effect the extraction of target molecules T, as depicted in FIG. 4B. During this time period, the tube 2201 may be heated and/or agitated, such as via vibration, rotation, stirring, and/or mixing via any of a variety of mechanisms known to those skilled in the art, to facilitate the mixing of the lysis medium and sample and/or the disruption of the sample to extract target molecules, including, for example, extracting the target molecules from entities containing target molecules. In an exemplary embodiment, beads (not shown) may be added to the tube 2201 and the tube 2201 may be agitated to effect disruption of the entities, which may be desirable, for example, in cases where the cells and/or other entities are more difficult to disrupt, such as for example in the case of Lysteria spp or a cell wall. In the state shown in FIG. 4B, the barrier member 3304 attached to the filter 3302 prevents the contents of the tube 2201 above the filter 3302 from flowing through the filter 3302 past the barrier member 3304 and through egress opening 2205. This enables the disruption process to proceed in the tube 2201 without the contents of the tube 2201 being allowed to flow through the filter 3302 past the barrier member 3304 and out of the opening 2205. Further, as noted above, in various exemplary embodiments, the filter 3302 may be hydrophobic, thereby minimizing or preventing the passage of the contents of the tube 2201 into the pores of the filter 3302 while the disruption process is occurring.

After sufficient time has passed to allow for disruption and release of target molecules, in FIG. 4B, the tube 2201 with the contents therein, which include the extracted target molecules T, debris from disrupted entities and/or other material of larger size, such as, sample material insoluble in the lysis medium (generally indicated at D), lysis medium and/or reagent M, and any other substances present in the tube 2201, may be placed in conjunction with a collection tube 4001. In an alternative exemplary embodiment, the collection tube 4001 and the tube 2201 could be in an assembled state at the initiation of the workflow. For example, the two components could be assembled manually or could be in a pre-assembled state upon first use, such as for example, molded together or otherwise mated together in a substantially leakproof manner.

With reference to FIG. 4C, the barrier member 3304 may be altered from the state in FIG. 4B in which the barrier member 3304 prevents the passage of material above the filter 3302 past the barrier member 3304 toward the egress 2205 to the state illustrated in FIG. 4C wherein the barrier member 3304 permits the passage of at least some of the contents in tube 2201 (namely those contents that are able to pass through the filter 3302) therethrough toward the egress 2205.

In at least one nonlimiting exemplary embodiment, the tube 2201 and the collection tube 4001 can be centrifuged together with the lid 2204 closing the opening 2203, for example, using a microcentrifuge or other centrifuging instrumentation with which those having ordinary skill in the art are familiar. During centrifuging, the force exerted on the barrier member 3304 causes the barrier member 3304 to rupture, as depicted in FIG. 4C. The target molecules T, soluble matter from the sample, and any lysis, reagent, and/or other liquid-based substances M in the tube 2201 can then pass through the filter 3302 and flow past the barrier member 3304 and out egress opening 2205 into the collection tube 4001. In embodiments wherein the filter 3302 is hydrophobic, the force associated with the centrifuging overcomes the forces associated with repelling the liquid substances due to the hydrophobicity of the filter 3302 to cause the target molecules, liquid substances, and material smaller than a threshold size to pass through the filter 3302. Material of larger size, such as, for example, sample material that is insoluble in the lysis medium (including but not limited to, for example, foodstuffs, tissue, keratinous fibers, clothing, soil, bone and/or any other solid matter present in the original sample), debris from entities disrupted during the disruption process, and the like (generally labeled as D in FIG. 4C) can be separated from the smaller and/or liquid contents of the tube 2201 due to the inertial forces acting on the larger (e.g., heavier) material and can be excluded from passage through the small pores of the filter 3302, thereby remaining in the tube 2201. After centrifuging is complete, therefore, the target molecules T, along with lysis medium and/or other reagents if present, will be separated from other, larger portions of the sample material and contained in the collection tube 4001, for example, in an amount sufficient to perform desired assay and analysis, such as, for example, PCR.

Although centrifugation represents one exemplary technique for altering the state of the barrier member in accordance with the teachings herein, as described above, a variety of other mechanisms can be employed to alter the barrier member to permit passage of substance therethrough. Other techniques include, but are not limited to, for example, creating a positive or negative pressure within the tube 2201 via a variety of mechanisms described above to cause the barrier member 3304 to yield (e.g., rupture), using a chemical or thermal application to deteriorate (e.g., dissolve or melt) the barrier member, or using osmosis to pass some material through the barrier member.

In accordance with various exemplary embodiments, as described above, the material and thickness of the barrier member 3304, as well as any tension applied to the barrier member 3304 via its attachment to the filter 3302, may be selected so as to achieve rupture of the barrier member 3304 upon a sufficient, preselected pressure exerted thereon. In an alternative exemplary embodiment, to achieve rupture of the barrier member, the barrier member may be a plastic film material that includes discrete regions that are thinner than other regions so as to cause failure and rupture of the barrier member at least at one or more of those regions upon the exertion of sufficient pressure thereon. By way of nonlimiting example, FIG. 5 depicts a plan view of an exemplary embodiment of a barrier member 5304 that includes discrete thinner regions 5305. The thinner regions 5305 may be formed as blind holes, for example, by etching, laser-ablation, embossing, scoring, or other similar technique, for example using a mask to form the regions 5305. Those having ordinary skill in the art are familiar with a variety of such techniques. Those having ordinary skill in the art would also understand that the blind holes 5305 depicted in FIG. 5 are exemplary only and other shapes and configurations of thinner regions of materials may be utilized, including but not limited to, score lines.

In yet another exemplary embodiment, a barrier member may be a liquid-impermeable material having adhesive on at least portions of the surface facing the filter. The adhesive may serve to attach the barrier member to the filter and have sufficient strength to maintain the attachment of the barrier member to the filter so that contents of the tube do not move past the barrier member until desired. When desired, the barrier member may be subject to sufficient pressure, for example, caused by centrifuging the tube and/or otherwise increasing the pressure within the tube. Upon reaching a sufficient level, the force exerted on the barrier member may overcome the force of the adhesive, causing the barrier member to be removed from the filter and permit contents of the tube to pass through the filter and past the initial position of the barrier member.

In various exemplary embodiments, a barrier member in accordance with the teachings herein may be colored and/or have a pattern or other feature so as to enhance visualization of the barrier member on the filter, thereby helping to ensure a desired orientation of the filter and barrier member in a sample preparation chamber. (e.g., with the barrier member facing the egress of the sample preparation devices of the exemplary embodiments depicted herein, although such orientation is exemplary only).

In various exemplary embodiments, the filter and barrier member structure may be formed by placing a sheet of plastic film (i.e., the plastic film material of which the barrier member is made) over a layer of filter material (e.g., a layer of frit material). With the sheet of plastic film smoothly and tightly pulled against the layer of filter material, the sheet and layer may be punched together, for example, using a die punch (e.g., a circular die punch). The co-punching process may cause the plastic film to be substantially exactly aligned (with minimal or no margins) with the filter and stretched tightly and smoothly against the filter material, pressure-adhering the plastic film to the filter so as to form the filter and barrier member component substantially as shown and described in the exemplary embodiments above.

As an alternative to the above formation, the barrier member may be formed as a skin on the filter material. For example, a layer of frit material may be processed by subjecting one surface of the layer to a controlled thermal treatment that melts the frit material to fuse together the surface material to form a substantially continuous, nonporous surface. After processing, as above, a die punch may be used to cut several filter/barrier members from the skinned layer of frit material. In another exemplary technique, a skin may be formed on the surface of the frit material layer by overlaying a sheet of thin plastic film, as described above, and further compressing the sheet of thin polymer film against the sheet of frit material along with the addition of heat to form at least a temporary bond between the plastic film and frit layer. As above, a die punch may then be used to punch out several filter/barrier member elements.

As mentioned above, various exemplary embodiments of sample preparation devices may be used in conjunction with the teachings herein and the single processing tube configuration that feeds into a collection tube that is depicted in FIGS. 2 and 4 is nonlimiting and exemplary only. In various other exemplary embodiments, sample preparation devices can comprise a series of more than one processing tube, each separated from flow communication with one another at least initially by barrier members. In other exemplary embodiments, a single processing tube can include a series of compartmentalized processing chambers separated from each other at least initially by barrier members. Some nonlimiting exemplary embodiments of such configurations are depicted in FIGS. 10-12 described below.

With reference to FIGS. 10A and 10B, an exemplary embodiment of a sample preparation device 1000 that comprises three tubes 1001, 1003, and 1005 is illustrated. As depicted in FIG. 10A, the tubes 1001, 1003, and 1005 are configured to be assembled together in a nested arrangement. The assembly can occur at the time of use or the tubes can be pre-assembled. In an exemplary embodiment, the tubes in the assembled arrangement should be sealed so as to prevent leakage of the contents of the tubes between the nested tubes. In various exemplary embodiments, seal rings and/or aprons could be incorporated in the assembled arrangement, which may be desired, for example, if vacuum is used in conjunction with the assembly to yield the barrier members. In an exemplary embodiment, the tube 1005 is a collection tube having a closed end that is configured to be removed from the remaining tubes for further analysis, processing, and/or disposal. There may be more than one collection tube provided, for example one to collect unwanted reactants and material from the sample preparation and one to collect the desired sample product for further processing and/or analysis. Further, although not illustrated, a cap can be provided to cover the collection tube 1005 upon separating it from the remainder of the device 1000. For purposes of clarification and visualization of the various components, FIG. 10B depicts the tubes of the sample preparation device 1000 in an unassembled state.

In the exemplary embodiment of FIG. 10, the sample preparation device 1000 includes a tube 1001 into which sample for processing may be introduced through an ingress 1013 and contents may exit the tube 1001 via an egress 1015. The tube 1001 can have a configuration similar to the tube 2201 described above with reference to FIG. 2 and thus similar parts and features are not necessarily described here. A sample S along with desired reagents in a liquid-based media M can be disposed in the chamber 1007 above a barrier member 1304 situated proximate the egress 1015. Although FIGS. 10A and 10B illustrate a barrier member 1304 in isolation, those having ordinary skill in the art will appreciate that, depending on the particular application of the sample preparation device 1000, the barrier member 1304 can be in combination with a filter or other supporting structure, as described with respect to other exemplary embodiments herein.

In accordance with the teachings herein, the barrier member 1304 can be alterable between a first and second state to respectively prevent and permit passage of the liquid-based media M and/or other contents of the chamber 1007 to flow toward the egress 1015. As above, in exemplary embodiments, the barrier member 1304 can be altered from the first to the second state after a time period sufficient to permit a desired reaction of the sample S to take place in the chamber 1007. Any of the mechanisms for altering the barrier member 1304 described herein can be employed.

The tube 1003 is nested with the tube 1001 to receive contents that exit the tube 1001 through the egress 1015. In the exemplary embodiment of FIG. 10, the tube 1003 includes a multi-laminate structure that includes a frit or other size-exclusion filter layer 1302, a functionalized resin layer 1312 that can be configured to perform various functions described in more detail below, and a barrier member 1314, which can have a configuration like that of barrier member 1304. Those having ordinary skill in the art will appreciate based on the teachings herein that any of the structures 1304, 1302, 1312, and/or 1314, individually or combined, can be associated with a sealing mechanism like that described with reference to FIG. 9 to prevent leakage of substance between the structures and the interior walls of the tubes 1001 and 1003.

In various exemplary embodiments, and depending on the particular sample preparation application, the layer 1302 can be a filter that excludes or permits passage of material on the basis of size; in other words, the layer 1302 can permit passage of material smaller than a threshold size and prevent passage of material greater than or equal to the threshold size. The filter 1302 can be a frit or other porous material, as described above with reference to the filters 202 and 3302.

The functionalized resin 1312 can be made of various materials and perform various functions. By way of example only, the resin 1312 can be configured as a molecular sieve or other size exclusion or separation mechanism configured to exclude and or separate material based on size. The resin 1312 can be configured to separate smaller size material than the filter 1302 either by completely preventing passage of some material or by permitting passage at different rates through the material (e.g., similar to electrophoresis gels in which case an electric field may be applied across the resin if needed). In addition or in lieu of performing a size exclusion or separation function, the resin can comprise various constituents for reacting with material passing through the resin. For example, the resin 1312 can comprise constituents that enable ion-exchange and/or affinity binding of materials passing therethrough, for example, to capture such materials in the resin. Examples of functionalized resins for affinity capture include, but are not limited to, inert, low binding, low biological activity resins such as beaded polydextran, polyacrylamide, or cellulose, to which affinity ligands such as antibodies, antibody fragments, biotin, avidin, protein A/G, known ligands, aptamers, substrates, substrate analogs, agonists, antagonists, that can exhibit reversible high specificity binding to one or more of the reactants/products in tube 1001 that are partially purified by transit through the filter layer 1032. In various exemplary embodiments, the resin 1312 is kept hydrated with a liquid prior to the introduction of the contents from tube 1001, and the barrier member 1314 is used to seal the hydrating liquid in the tube 1003.

As with the barrier member 1304, the barrier member 1314 has a first state that prevents the passage of the contents in tube 1003, at least for a time period after contents from tube 1001 have been introduced to the tube 1003. The time period may be sufficient to permit the desired processing of the sample portions introduced into tube 1003 to occur, for example, to allow size separation and/or a capture reaction (e.g., an affinity binding reaction or ion-exchange reaction) to occur in the resin 1312. Thereafter, the barrier member 1314 can alter, via any of the various mechanisms described herein, to a second state that allows the contents of the sample that pass through the size-exclusion filter 1302 and the resin 1312 to flow toward the egress 1035. Contents of the tube 1003 that pass through the egress 1035 can flow into the collection tube 1005.

In an exemplary embodiment, the collection tube 1005 can collect waste from the processing of sample S while the resin 1312 captures and retains reactants or portions of the sample S for which further processing and/or analysis is desired. In such a case, the collection tube 1005 containing the waste can be removed from the tube 1003 and the tube 1005 and waste contained therein discarded as appropriate (a cap (not shown) could be provided to seal the tube 1005 and waste therein for disposal). After removal of the collected waste, an additional collection tube can be placed in nesting engagement with the tube 1003 and a substance can be introduced into the sample preparation device 1001, for example through the ingress 1013 or alternatively directly into tube 1003 (either by removing the tube 1003 from engagement with the tube 1001 or via a port or other inlet placed in a side wall of the tube 1003, as further described with reference to FIG. 11). The substance introduced can elute the desired reactants and/or processed sample captured in resin 1312 from the resin 1312 and into the additional collection tube, which can be used for additional analysis and/or further processing.

In one exemplary application, the sample preparation device 1000 may be used to perform a reaction, desalting, and collection process in which a reaction of the sample S occurs in the tube 1001 after which reaction the barrier member 1304 is altered to a state (for example, using any of the techniques described herein) that allows for the reacted sample and other contents in the tube to flow past the initial location of the barrier member 1304, through the egress 1015 and into tube 1003. In tube 1003, products of the reaction in tube 1001 can be filtered and further processed as they pass through the filter layer 1302 and resin 1312. Regarding the latter, for example, the functionalized resin 1312 can perform one or more additional treatments and/or processes on the sample portions passing therethrough. As above, after a sufficient time period in which the desired reaction (e.g., processing) has been allowed to occur in tube 1003, the barrier member 1314 can be altered to the second state to permit the passage of contents that pass through the filter 1302 and resin 1312 into the collection tube 1005 where the treated sample can be ready for further processing and/or analysis.

In various exemplary embodiments, it may be desirable to have numerous different functionalized resins, like resin 1312, that are configured to perform differing functions. For example, an additional resin disposed downstream of resin 1312 can function to further purify, separate, and/or capture material of interest in the sample preparation process. FIGS. 11A and 11B depict an exemplary embodiment of a sample preparation device 1100 that includes the tubes 1001, 1003, and 1005 of the exemplary embodiment of FIG. 10, with an additional tube 1007 interposed between tube 1003 and collection tube 1005. FIG. 11A shows the tubes in their nested, assembled arrangement and FIG. 11B shows the tubes separated. The tube 1007 may have a configuration similar to tube 1003 and include a multilaminate structure comprising, for example, a size-exclusion filter member 1322 (e.g., frit), a functionalized resin 1332, and a barrier member 1324. In the exemplary embodiment of FIG. 11, the resins 1312 and 1332 may be configured (e.g., functionalized) to perform differing functions. By way of nonlimiting example, the resin 1312 can be configured for separation of material via size (which can include either size exclusion or size separation within the resin) and/or as a capture resin, (e.g., relying on an exchange or affinity binding mechanism) to capture materials of interest from the processed sample. As depicted in FIGS. 11A and 11B, if resin 1332 is utilized as a capture resin, an input 1072 may be provided on the side wall of the tube 1007 to permit the introduction of an eluting substance to elute the captured material from the resin 1332 when desired. The input 1072 in an exemplary embodiment can be a septum that permits the sealed introduction of a syringe or the like; other input mechanisms may also be utilized, however, and the particular type of input is not critical, although it may be desirable to provide an input mechanism that can be sealed when not being used to introduce substance to the tube 1007. As described above with reference to FIG. 10, the sample preparation device 1100 can include more than one collection tube 1005 so that one can be used for collection of waste materials from the sample preparation conducted in the device 1100 and one can be used for the collection of processed or prepared sample for which further analysis and/or use is desired.

The filter members (including functionalized resins) and barrier members in the sample preparation devices 1100 can have configurations and functions that are substantially the same as those described above with reference to FIG. 10. Those of ordinary skill in the art will appreciate that when sample preparation devices in accordance with various exemplary embodiments herein have multiple filters and barrier members, the filters and barrier members need not have the same configuration. Rather, the filters can effect the filtering of different size materials and/or be functionalized in differing manners, and the barrier members can be configured to yield (e.g., alter to the second state) under differing conditions, for example.

Referring now to FIG. 12, another exemplary embodiment of a sample preparation device 1200 that includes a series of nested tubes is illustrated. FIG. 12 shows the sample preparation device 1200 in an unassembled arrangement, however, it will be appreciated that the tubes can be assembled in a nested arrangement similar to those shown in FIGS. 10A and 11A. The exemplary embodiment of FIG. 12 includes an initial sample receiving tube 1201 that can be configured like tubes 201, 2201, and 1001 described above and include a barrier member 1204, which in exemplary embodiments can be by itself or in combination with a supporting filter member or other structure, such as a frit, like the filter/barrier member combination described with reference to FIGS. 2 and 4. The sample preparation device 1201 also can include one or more collection tubes 1205, for example to receive prepared sample for further processing, use, and/or analysis or to receive waste products from the sample preparation process.

The sample preparation device 1200 also includes an additional processing tube 1209 interposed in a nested arrangement between the tubes 1201 and 1205. Within the tube 1209, a plurality of barrier members 1214, 1224, 1234, and 1244 in a first state may be disposed in series so as to define, with the tube 1209 a series of compartments or chambers that contain reagents, R1, R2, R3, R4 that are separated from each other via the respective barrier members 1214, 1224, 1234, and 1244. In various exemplary embodiments, one or more of the reagents R1, R2, R3, and R4 can differ from each other and support differing reactions.

In use, therefore, the sample preparation device 1200 can utilize the tube 1201 to support an initial reaction, as has been described herein with reference to other exemplary embodiments, and the tube 1209 can be used to carry out a series of reactions with each of the reagents R1-R4 in a consecutive manner by controlling when each of the barrier members 1214, 1224, 1234, and 1244 is altered to the second state wherein the passage of sample past the initial location of each respective barrier member is enabled. Those having ordinary skill in the art will appreciate that any number of barrier members and reagents (e.g., the number of segregated compartments within the tube 1209, can be used and the 4 reagents and barrier members illustrated is exemplary only. Depending on the particular application and sample processing desired, the barrier members may be combined with filter members (including functionalized resins) to achieve a variety of processing reactions, as described herein. After the series of reactions has taken place and the final barrier member 1244 has been altered to the second state to allow flow of contents from the tube 1209 toward the egress 1235, contents of the tube 1209 can be collected in collection tube 1205.

Due to the arrangement of the reagent-containing compartments, the exemplary embodiment of FIG. 12 may be suitable for the use of osmotic barrier members in cases in which the reagents are in liquid form.

In one exemplary embodiment, the sample preparation device 1200 can be used to perform an enzyme-linked immunosorbent assay (ELISA). To carry out such an assay, for example, the sample of interest S may be introduced into the tube 1201 where a lysis or other disruption reaction can take place to release target molecules from the sample S. In an exemplary embodiment, the lysis reaction can include a chemical lysis reaction using lysis reagents in a liquid-based medium M. Once the lysis has taken place, the barrier member 1204 can be altered to permit passage of contents from the tube 1201 into the tube 1209. A filter can be disposed in tube 1201 to exclude from passage debris and/or other material larger than or equal to a threshold size. The contents from tube 1201 that pass through egress 1215 and into tube 1209 can be held in the compartment containing reagents R1 above the barrier member 1214, which can include one or more reagents that effect desalting of the sample. After a sufficient time has passed for the desalting reaction, the barrier member 1214 can be altered to permit the contents from the desalting reaction to pass to the compartment defined above barrier member 1224, in which ELISA reagents R2 may be held. An antigen-antibody binding reaction can be performed at this point, after which the barrier member 1224 can be altered to pass the resultant reactant products to the compartment above the barrier member 1234 wherein a reaction with the reagents R3, which can include reagents for the removal of unincorporated fluorgenic reagents, can take place. After that reaction, the eluate can be collected in the tube 1205 (in such application, the reagent R4 and barrier member 1244 may not be required).

Of course those having ordinary skill in the art will appreciate that the nested tube embodiments and workflows shown and described with reference to FIGS. 2, 4, and 10-12 are exemplary and nonlimiting, with various modifications that can be made to the configurations depending on the particular application desired without departing from the scope of the present teachings. Accordingly, it is envisioned that a number of nested tubes can be used with differing arrangements and numbers of barrier members, filters, and/or resins disposed therein. Furthermore, those having ordinary skill in the art would recognize that the tubes can include various input and output ports that would permit connection to various instruments and fluid handling devices, for example, to enable the introduction and or removal of reagents and/or other substances at differing locations and/or times within the system, or to enable a modification of pressure at differing locations within the overall system.

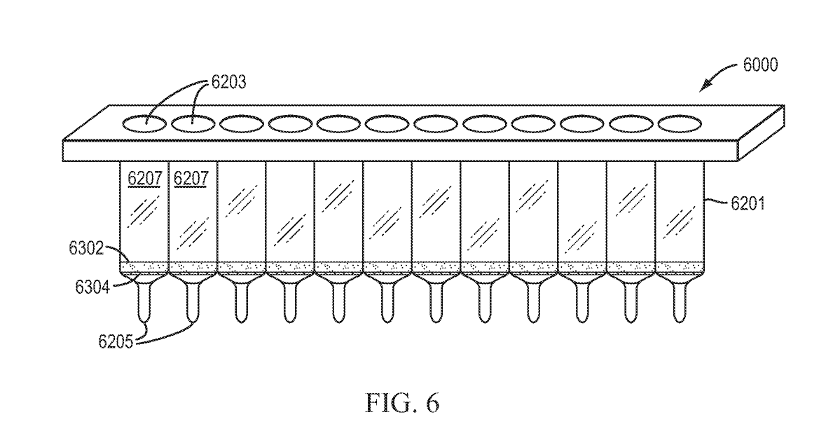

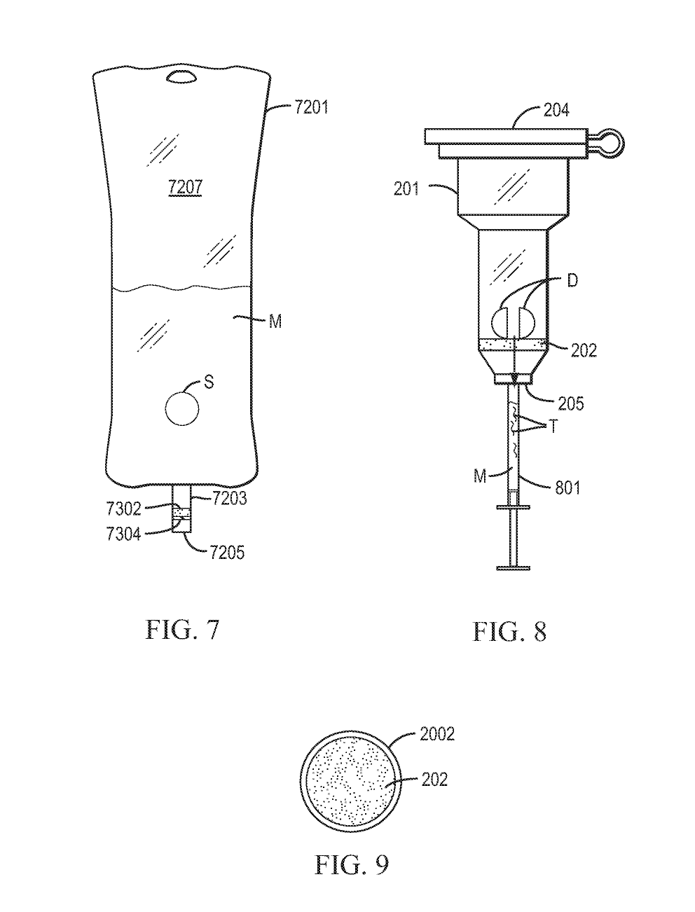

FIGS. 6 and 7 depict other nonlimiting, exemplary sample preparation devices that utilize the filter/barrier member elements in accordance with the present teachings, and as described above. In FIG. 6, a partial, side perspective view of a sample preparation device 6000 is shown comprising a plurality of individual sample preparation chambers 6207 formed by an array of tubes 6201 with filters 6302 with attached barrier members 6304 disposed therein, for example, proximate egress openings 6205 of the tubes 6201. The sample preparation device 6000 can have an array format similar to conventional well plates, including 96-, 384-etc. arrayed sample preparation chambers, however other formats also are within the scope of the teachings herein, including arrays having 14 tubes 6201 or more in a row. In such an embodiment, those having ordinary skill in the art would appreciate that only a single row of tubes 6201 of the array is depicted in FIG. 6. The multiple sample preparation device format depicted in FIG. 6 can be utilized with any of the sample preparation nested tube configurations described herein and the particular structure of the tubes 6201 with the filters 6302 and barrier member 6304 is by way of nonlimiting example only to depict the arrangement.

Various exemplary embodiments within the scope of the teachings herein contemplate the use of container structures other than those shown and described above. FIG. 7, for example, depicts a sample preparation device comprising a flexible bag 7201 (e.g., flexible plastic pouch). The flexible bag 7201 defines a chamber 7207 configured to hold sample S and lysis and/or other reagents M. An egress port 7203 defining an egress opening 7205 may be provided at one end of the bag 7201 and the port may be configured to hold a filter 7302 and barrier member 7304 therein. The filters and barrier members of the exemplary embodiments of FIG. 7 may have configurations like those described above with reference to other exemplary embodiments of the present teachings, and functionalized resin structures also can be used although not specifically depicted in FIG. 7 for the purposes of simplicity. The use of the exemplary embodiments of FIGS. 6 and 7 for sample preparation may be substantially the same as that described above with reference to the tube of FIG. 2. For example, disruption may be permitted to occur, followed by selective filtration of the disrupted sample. The selective filtration may occur by exerting sufficient pressure on the barrier member to change the state of the barrier member to permit passage of contents in the sample preparation chamber through the filter from a first side to a second opposite side. In the exemplary embodiment of FIG. 7, pressure sufficient to alter the state of the barrier member may include the various ways set forth above (e.g., including via centrifuging or other pressure-creating technique), and additionally, for example, by applying a force to the outer surface portions of the bag 7201 to compress the bag 7201 and increase the pressure in the chamber 7207 defined by the bag 7201. Other mechanisms for altering the state of the barrier member that are described herein also can be employed.

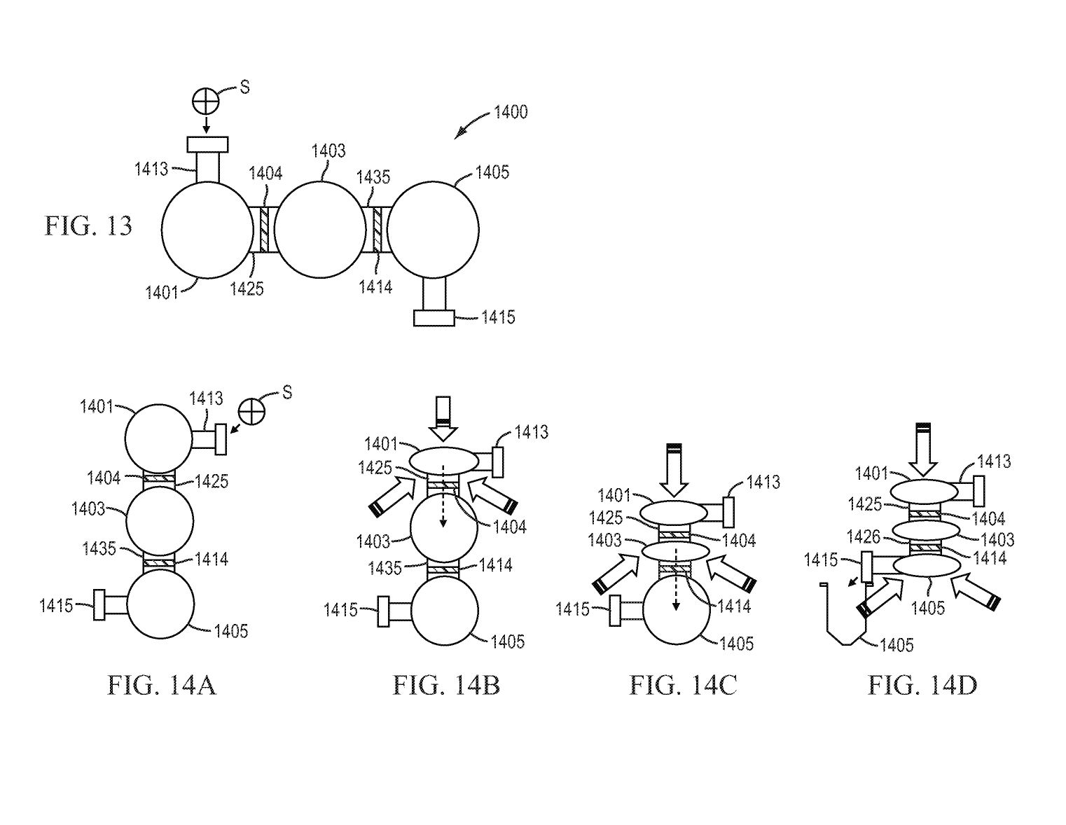

In various exemplary embodiments, multiple flexible bags or chambers can be connected together in series to perform workflows that enable differing processes and/or reactions to occur in a sequential fashion, for example, similar to those described with reference to the nested tube configurations described above. FIG. 13 schematically depicts an exemplary embodiment of a sample preparation device 1400 that includes multiple flexible, deformable containers 1401, 1403, 1405 defining differing chambers fluidically connected in series and separated from flow communication with each other via barrier members 1304 and 1314, at least in an initial state prior to use. FIGS. 14A-14D depict an exemplary embodiment of using the sample preparation device 1400.

The sample preparation device 1400 may include an input port or other ingress 1413 configured to receive a sample S for introduction into the flexible container 1401 for preparation and processing. The various containers 1401, 1403 and 1405 can be fluidically interconnected to each other via connecting passages 1425 and 1435, and an overall output port or other egress 1415 can be provided in communication with the most downstream container 1405. A collection component (e.g., collection tube 1405 shown in FIG. 14D) also can be provided to receive waste and/or processed sample from the device 1400. As described above, barrier members 1404, 1414 can be disposed in each of the connecting passages 1425, 1435 to isolate the contents in consecutive containers 1401, 1403, 1405 until such time as is desired to move contents from one container to another.

In one exemplary embodiment depicted in FIGS. 14A-D, an external force, represented by the large arrows in FIGS. 14B-14D can be applied to the containers 1401, 1403, 1405 to deform the containers and thereby increase pressure within the chambers of the containers to an amount sufficient to alter the barrier members 1404, 1414. Thus, in FIG. 14A, sample S may be introduced via input port 1413 into container 1401. The sample S can be permitted to react with reagents and/or other medium present in container 1401 for a desired amount of time, after which, an external force may be applied to the container 1401, as depicted by the large arrows in FIG. 14B. The force may be sufficient to deform and collapse the outer wall portions of the container 1401, causing an increase in pressure in the interior chamber of the container 1401 and thereby altering the barrier member 1404 (e.g., rupturing or otherwise yielding) to a state that permits passage of the contents in container 1401 to flow into the container 1402, as depicted by the dashed arrow of FIG. 14B. In container 1403, an additional reaction can occur, and after a desired time period, an external force may be applied to container 1403, as depicted by the large arrows in FIG. 14C. The force can be sufficient to collapse the container 1403 and increase the pressure in the container 1403 to a level sufficient to alter the barrier member 1414 to a state that permits the passage of the contents in container 1403 to flow to container 1405. From 1405, the contents can be directed through egress 1415, again by applying an external force to deform and collapse the container 1405, and into a collection container 1405, as shown in FIG. 14D. Backflow of contents in the sample preparation device may be controlled by maintaining the application of pressure on a container once it is collapsed. Further, although the orientation depicted in FIGS. 14A-D may facilitate flow through the device because of the gravitational forces assisting in the flow, it is contemplated that the device 1400 could be oriented horizontally as well.

As with other embodiments described above, various combinations of barrier members and filters (including functionalized resins) can be employed in the sample preparation device of FIGS. 13 and 14A-D, for example, to filter larger size material from being passed from container to container and/or to effect various capture, size separation, and/or other desired reactions. For simplicity, only the barrier members have been depicted in FIGS. 13 and 14A-D to demonstrate the fluidic communication between the various chambers. It will also be appreciated that the number of containers illustrated in FIGS. 13 and 14A-D is nonlimiting and exemplary only, and any number of containers can be used without departing from the scope of the teachings herein.

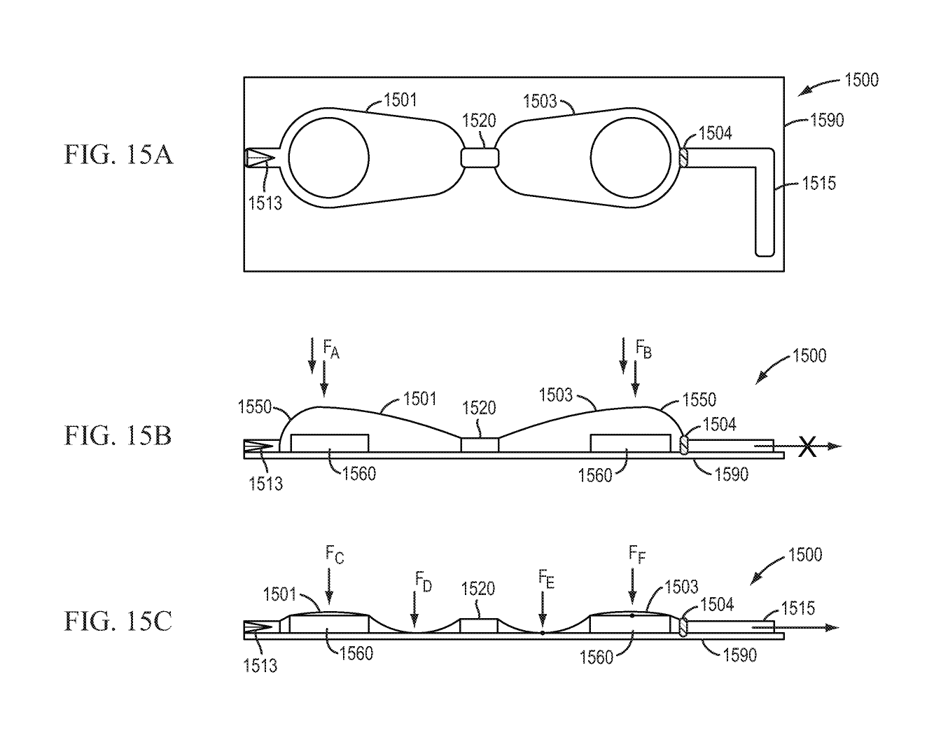

Another exemplary embodiment of a sample preparation device that relies on deformable, flexible containers is depicted in FIGS. 15A-15C. The device of FIGS. 15A-15C can comprise a card (e.g., microcard) type format that includes a rigid or semi-rigid substantially planar support 1590, upon which are mounted deformable, flexible layers 1550 that together with the planar support 1590 define chambers within the flexible, deformable containers 1501, 1503. The sample preparation device 1500 can include an ingress 1513, which can be valved as shown or have a variety of configurations to permit introduction of sample and/or other substances to container 1501 while preventing leakage therefrom during sample preparation. An egress 1515 can be in flow communication with container 1503 to flow substances out of the device 1500 as desired. The layers 1550 can be formed of various flexible, deformable materials, including but not limited to various plastics and polymeric materials Exemplary materials that are suitable for the layers 1550 include, but are not limited to, for example, polypropylene, polyethylene, and various copolymers.

A nebulizer 1520 can be disposed between the containers 1501 and 1503 through which flow communication between the two containers 1501 and 1503 can occur. Disposed in the interior of each container 1501 and 1503 are pumping blocks 1560 with which those ordinarily skilled in the art have familiarity and whose function will become apparent from the description that follows. A barrier member 1504 can be disposed between the container 1503 and the egress 1515.

An exemplary embodiment of using the sample preparation device 1500 will now be described with reference to the side views of the device in FIGS. 15B and 15C. Sample can be introduced into container 1501, for example, via ingress 1513. Container 1501 can also contain various reagents and/or other substances which may be desirable for a particular application, such reagents and/or other substances can be predisposed in the container 1501 or introduced via the ingress 1513. As shown in FIG. 15B, the sample in the container 1501 can be transferred back and forth one or more times between container 1501 and 1503 by applying an alternating external force FA and FB on the layers 1550 forming containers 1501 and 1503 substantially corresponding to the locations of the pumping blocks 1560. By alternating the application of the forces FA and FB, the sample can be moved between the two containers 1501 and 1503 through the nebulizer 1520. Passing the sample through the nebulizer 1520 can cause disruption of entities contained in the sample in a manner similar to that which has been described above with reference to other exemplary embodiments herein. By applying force at the pumping blocks 1560, the pressure in the containers 1501 and 1503 can be controlled to be kept below a pressure that would alter (e.g., burst) the barrier member 1504.

Once a desired level of disruption has occurred, external forces can be applied substantially simultaneously across all of the layers 1550 forming containers 1501 and 1503, as shown, for example, by force F_{C}, F_{D}, F_{E}, and F_{F} in FIG. 15C. The application of these forces can increase the pressure within the containers 1501 and 1503 to cause the barrier member 1504 to be altered so as to permit passage of contents of the chambers 1501 and 1503 to the egress 1515 and out of the device 1500.

Those having ordinary skill in the art will appreciate that although only two containers are depicted in the exemplary embodiment of FIG. 15, more than two containers could be fluidically connected to one another in series with barrier members disposed to separate the container chambers from flow communication at least initially. Further, based on the teachings herein, those ordinarily skilled in the art would understand how the embodiment of FIG. 15 could be modified to achieve various processing steps, such as filtration, size separation, binding reactions, exchange reactions, lysis, and/or a variety of other reactions and/or processing steps as desired for a particular sample preparation and/or processing application.

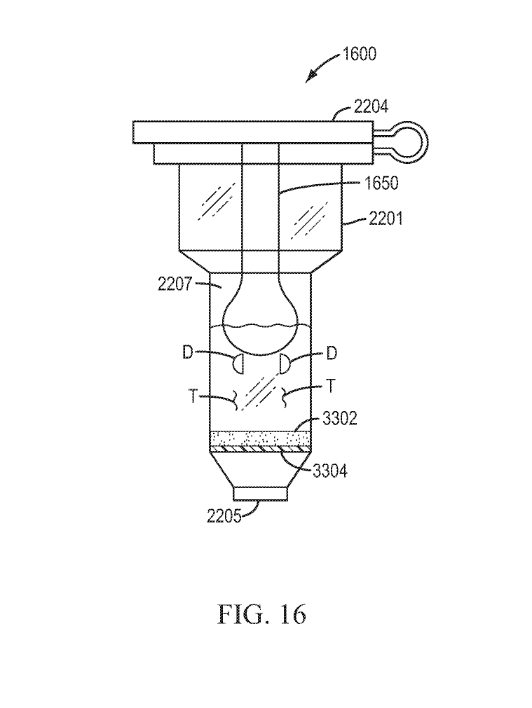

Various exemplary embodiments shown and described above contemplate the introduction of sample either by depositing the collected sample into the initial processing chamber and/or through a syringe or other similar fluid handling device that could be connected to the container defining the chamber. In at least one exemplary embodiment, the sample preparation devices in accordance with the teachings herein could also be configured for sample collection by, for example, integrating any number of various sample collection components that are known in the art, such as swabs, fabrics, and other textiles. FIG. 16 schematically depicts one exemplary embodiment of a sample preparation device 1600 that has a sample collection swab 1650 integrated in the cap 2204 of the a tube 2201 into which it is desired to introduce sample for sample preparation and processing in accordance with the teachings herein. Other than the sample collection swab 1650, the device 1600 has the same structure as the tube 2201 of FIG. 2 and thus the labeling has not changed. It should be appreciated however, that other exemplary embodiments of sample preparation devices herein can include an integrated collection structure, such as swab 1650, for example. Although in various exemplary embodiments described herein, disruption occurs via chemical or enzymatic lysing, those skilled in the art would understand that a variety of other techniques, including, mechanical and thermal techniques, may be used to cause disruption of the sample, and such techniques may be used in conjunction with or in lieu of chemical and/or enzymatic lysing.

Although in exemplary embodiments shown herein, the filter and barrier member are depicted as being located within a sample preparation chamber proximate the egress of the chamber, it would be appreciated by ordinarily skilled artisans that the filter and barrier member could be disposed at various locations of a sample preparation device without departing from the scope of the teachings herein. The location of the filter and barrier member within the sample preparation device may depend on the volume of contents that may be desired to be held in the device, for example. Moreover, as described with respect to various embodiments, the barrier members, filter members, and/or resins can be separated from each other and need not be bonded or otherwise in contact with each other. Thus, in various exemplary embodiments, a barrier member could be supported by itself via a sealing mechanism 2002 as depicted in FIG. 9, without requiring the support of a frit or other structure.

Although in various exemplary embodiments, a filter and barrier member are shown disposed such that the barrier member faces an egress of the sample chamber, it is contemplated as within the scope of the present teachings that the orientation of the filter and barrier member could be reversed such that the filter faces the egress of the sample preparation chamber and the barrier member is disposed upstream of the filter in the direction of flow from the sample chamber toward the egress. In yet another exemplary embodiment, barrier members may be positioned on both sides of a filter (including a functionalized resin).

In various exemplary embodiments, the sample preparation devices in accordance with the present disclosure may be disposable and configured for single-use applications. Alternatively, other exemplary embodiments contemplate sample preparation devices that can be reused, for example, by replacing the used filter, resin, and/or barrier member with a new components and sterilizing the sample preparation chamber (e.g., the tube and/or other container). Also, it is contemplated that various exemplary embodiments can be portable so that sample collection and preparation can be performed at the same location or point of collection, for example, without the need for complex equipment, such as for example centrifuges and the like.

Various exemplary embodiments contemplate the use of reagents and/or other reactive substances being disposed in the various containers (e.g., chambers) of the sample preparation devices. It is contemplated that such substances can be introduced by an individual using the device or can be predeposited (e.g., in lyophilized form) in the device.

Modifications to the tubes, bags, and other container structures described herein are also envisioned and contemplated as being with the scope of the teachings herein. The containers or structures defining serially connected chambers can have various configurations and the exemplary embodiments of container structures depicted in the drawings should not be construed as limiting.

It will be appreciated by those ordinarily skilled in the art having the benefit of this disclosure that the teachings herein provide various exemplary devices and methods for sample preparation for assay and analysis useful for various biological, chemical, and cytobiological applications. Although various workflows described above set forth exemplary uses and applications for the sample preparation devices and techniques described herein, those having ordinary skill in the art will appreciate numerous other applications for which the device and techniques herein could find use. For example, the devices and techniques herein can be applied for use in a variety of self-contained, single use reaction-to-purified sample product devices. Such devices can be used, for example, to carry out covalent chemical and enzyme catalyzed addition; substitution or elimination reaction; or combination of participants of non-covalent binding processes, which can occur in a most upstream reaction chamber separated from downstream chambers by alterable barrier members made from, for example, polymer membranes, foils, phase-changeable substances (e.g., solid to liquid) or deformable materials (i.e., rubber, waxes, soft plastics, hydrogels, etc.). In the downstream chamber(s), reactions can occur that can include but are not limited to chemical coupling of ligands to proteins, DNA, RNA, lipids, carbohydrates, engineered reactive groups (i.e., biologically incorporated non-native amino acids and nucleic acids, cofactors) or non-biological polymers through reactions with, but not limited to, primary amines, carboxylates, sulfhydrils, hydroxyls, carbonyls, alkynes, epoxides, esters, azides, and the formation of stable metal chelates (dative bonding/coordination), etc. Reactants from sample preparation and/or processing can be safely handled and disposed of, and the device made to keep products sterile by controlling the manufacture process.

Moreover, sample preparation devices and techniques in accordance with exemplary embodiments herein can be used in the generation of short-lived, labile pharmaceuticals where pre-processing is required. Nonlimiting examples include radionuclide addition reactions including direct or indirect coupling of various isotopes in the halide family including Iodine, Rhenium, and Technecium (^{123, 125, 131}Iodine (I), ^{186, 188}Rhenium (Re), ^{99m}Technicium, as well as other radioactive metal isotopes with potential radiopharmaceutical uses such as Copper ⁶⁷Copper (Cu), ²¹¹Astatine (At), to proteins (e.g., antibodies, antibody fragments, receptor binding proteins and peptides, reactive ligands, etc.). Other reactions that can take place in the sample preparation devices in accordance with the teachings herein can include covalent coupling of dyes, fluorophores, quenchers, fluorescent or photoreactive nanoparticles, photoreactive heterocycles, specific targeting peptides, proteins or nucleic acids, enzymes and enzyme fragments, nucleic acid, peptide or protein-based aptamers, solubility modifiers (e.g., polyethylene glycol (PEG), polyethylene oxide (PEO), carbohydrates), thermoprotective/cryoprotective agents (e.g., sugars including mannose, trehelose, etc.); covalent coupling of lipids such as gerynylation, geranylgeranylation and prenylation; bisulfite conversion of unmethylated DNA; end-labeling of DNA with 32P; restriction digestion of DNA; and reaction involving click chemistry for labeling.

The present teachings are also directed to kits that utilize the components, including reagents, and methods described above. In some embodiments, a kit can comprise one or more containers having one or more specific reagents therein or to be added thereto, and a collection container. A kit can also optionally comprise instructions for use to perform a desired sample preparation and/or process application. A kit can also comprise other optional kit components, such as, for example, various enzymes, buffers, washes, controls, etc. Protocols and/or manuals may be provided to educate the user and limit error in use. The amounts of the various reagents in the kits also can be varied depending upon a number of factors, such as the optimum sensitivity of the process. It is within the scope of these teachings to provide test kits for use in manual applications or test kits for use with automated detectors or analyzers.

Further modifications and alternative embodiments will be apparent to those skilled in the art in view of the disclosure herein. For example, the systems and the method may include additional components or steps that were omitted from the diagrams for clarity of operation. Accordingly, this description is to be construed as illustrative only and is for the purpose of teaching those skilled in the art the general manner of carrying out the present teachings. It is to be understood that the various embodiments shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the spirit and scope of the present teachings and following claims.

Those having skill in the art would recognize that the various exemplary embodiments described herein may be modified to perform a variety of assays, and although some specific assay examples for which the systems and methods may be well-suited are disclosed, such examples are nonlimiting and exemplary only.

Those having ordinary skill in the art would understand that features, components, steps, and/or materials described with respect to a particular exemplary embodiment set forth herein may be used with one or more other exemplary embodiments set forth herein and modifications made accordingly. It is to be understood that the particular examples and embodiments set forth herein are nonlimiting, and modifications to structure, dimensions, materials, and methodologies may be made without departing from the scope of the present teachings.

Other embodiments will be apparent to those skilled in the art from consideration of the specification and practice of the present teachings disclosed herein. It is intended that the specification and examples be considered as exemplary only, with a scope being of a breadth indicated by the claims, including their full scope of equivalents.

1. A device for sample processing, the device comprising:
at least one chamber having an egress, said chamber being configured to receive a sample for processing;
a filter through which at least some sample portions in the at least one chamber flow;
a barrier member disposed in a first state to contain sample in the at least one chamber; and
at least a second chamber comprising a collection chamber fluidically connected in series with the at least one chamber and separated from flow communication with the at least one chamber via the barrier member in the first state,
wherein, upon sufficient conditions, the barrier member is alterable to a second state to permit flow of at least some sample portions contained in the chamber in a flow direction toward the egress and through the filter,
wherein the filter is configured to permit passage of target molecules contained in a sample introduced into the at least one chamber.

2. The device of claim 1, wherein the filter is configured to permit passage of sample portions smaller than a threshold size and block passage of sample portions of at least the threshold size.

3. (canceled)

4. The device of claim 1, wherein the filter is configured to block passage of at least some sample portions that are insoluble in a lysis medium.

5. The device of claim 1, wherein the filter comprises at least one of a frit and a functionalized resin.

6. The device of claim 1, wherein, at least in the first state, the barrier member is attached to the filter.

7. The device of claim 1, wherein the barrier member is alterable to the second state upon being subjected to sufficient force.

8. The device of claim 1, wherein the barrier member comprises a membrane.

9. The device of claim 1, wherein the filter and the barrier member are disposed in the at least one chamber between an ingress of the at least one chamber and the egress.

10. The device of claim 1, wherein the at least one chamber is defined at least partially by a deformable structure.

11. (canceled)

12. The device of claim 1, wherein the at least one chamber comprises a plurality of chambers arranged in an array.

13. (canceled)

14. The device of claim 1, further comprising at least one of an additional filter and an additional barrier member disposed in the at least one additional chamber.

15. (canceled)

16. The device of claim 13, wherein the at least one chamber and the at least one additional chamber are configured for nested engagement with each other.

17. A method for preparing a sample comprising: disposing a sample in a first chamber of a plurality of chambers fluidically connected in series,
wherein consecutive chambers are separated from each other by respective barrier members in a first state;
subjecting the sample to a processing assay in the first chamber; and
after a predetermined time period, flowing at least some sample portions from the first chamber to a second consecutive chamber by altering the respective barrier member separating the first chamber and the second consecutive chamber to a second state,
wherein the barrier member in the first state prevents flow past a location of the barrier member and wherein the barrier member in the second state permits flow from the first chamber to the second consecutive chamber,
wherein flowing the sample portions through the filter permits passage of the target molecules through the filter.

18. The method of claim 17, wherein the flowing comprises flowing sample portions through a filter that retains material of at least a threshold size in the first chamber and passes material smaller than the threshold size to the second consecutive chamber.

19. (canceled)

20. The method of claim 17, wherein altering the barrier member comprises exerting a force on the barrier member.

21. The method of claim 17, wherein subjecting the sample to a processing assay comprises subjecting the sample to disruption to extract target molecules form the sample.

22. The method of claim 21, wherein subjecting the sample to disruption comprises subjecting the sample to lysis.

23. The method of claim 21, wherein the target molecules are chosen from nucleic acids, peptides, proteins, and biopolymers.

24. The method of claim 17, further comprising subjecting the sample to a second processing assay in the second chamber; and
after a predetermined time period, flowing sample portions from the second chamber to a third consecutive chamber by altering the respective barrier member separating the second and third chambers from the first state to the second state.

25. A device for sample processing, the device comprising:
at least one chamber having an egress, said at least one chamber being configured to receive a sample for processing; and a barrier membrane in a first state disposed relative to the chamber, wherein in the first state the barrier membrane contains the sample in the chamber, wherein, upon sufficient conditions within the at least one chamber, the barrier membrane is alterable to a second state to permit flow of sample portions in the chamber in a flow direction toward the egress.
